(19) United States
(12) Patent Application Publication
(10) Pub. No.: US 2022/0291485 A1
(43) Pub. Date: Sep. 15, 2022

(54) Optical Imaging System

(71) Applicant: ZHEJIANG SUNNY OPTICS CO.,LTD., Ningbo (CN)

(72) Inventors: Quanfeng YANG, Ningbo (CN); Yinghui YUAN, Ningbo (CN); Fujian DAI, Ningbo (CN); Liefeng ZHAO, Ningbo (CN)

(21) Appl. No.: 17/673,817

(22) Filed: Feb. 17, 2022

(30) Foreign Application Priority Data
Mar. 5, 2021 (CN) 202110243816.7

(51) Int. Cl. G02B 13/00; G02B 9/64

(52) U.S. Cl. CPC G02B 13/0045; G02B 9/64

(57) ABSTRACT

The disclosure provides an optical imaging system, sequentially including from an object side to an image side along an optical axis: a first lens with a positive refractive power; a second lens with a refractive power; a third lens with a refractive power; a diaphragm; a fourth lens with a negative refractive power; a fifth lens with a positive refractive power, an image-side surface thereof is a concave surface; a sixth lens with a refractive power, an image-side surface thereof is a convex surface; and a seventh lens with a refractive power. At least one mirror surface from an object-side surface of the first lens to an image-side surface of the seventh lens is an aspheric mirror surface. A maximum field of view FOV of the optical imaging system and a distance SD from the diaphragm to the image-side surface of the seventh lens on the optical axis satisfy: 2.5 mm⁻¹<Tan(FOV)/SD<3.5 mm⁻¹.

### CROSS-REFERENCE TO RELATED PRESENT INVENTION(S)

The disclosure claims priority to and the benefit of Chinese Patent Present invention No.202110243816.7, filed in the China National Intellectual Property Administration (CNIPA) on 5 Mar. 2021, which is incorporated herein by reference in its entirety.

### TECHNICAL FIELD

The disclosure relates to the technical field of optical elements, in particular to an optical imaging system.

### BACKGROUND

As the society develops, portable electronic products such as smart phones and tablet personal computers have become indispensable tools in daily life gradually. In order to be adaptive to the portable electronic products such as mobile phones, the optical imaging system carried on the product such as the mobile phone gradually becomes smaller, lighter and thinner while guaranteeing the imaging quality, which poses difficulty for the design of the optical imaging system undoubtedly. Meanwhile, with the image sensor improved in performance and reduced in size, the corresponding optical imaging system has an increasingly less design freedom degree, and accordingly, the design difficulty of the optical imaging system is increased.

### SUMMARY

An embodiment of the disclosure provides such an optical imaging system, the optical imaging system sequentially includes from an object side to an image side along an optical axis: a first lens with a positive refractive power; a second lens with a refractive power; a third lens with a refractive power; a diaphragm; a fourth lens with a negative refractive power; a fifth lens with a positive refractive power, an image-side surface thereof is a concave surface; a sixth lens with a refractive power, an image-side surface thereof is a convex surface; and a seventh lens with a refractive power. At least one mirror surface from an object-side surface of the first lens to an image-side surface of the seventh lens is an aspheric mirror surface. TTL is a distance from the object-side surface of the first lens to an imaging surface of the optical imaging system on the optical axis, ImgH is a half of a diagonal length of an effective pixel region on the imaging surface of the optical imaging system, and TTL and ImgH may satisfy: TTL/ImgH<1.2. FOV is a maximum field of view of the optical imaging system, SD is a distance from the diaphragm to the image-side surface of the seventh lens on the optical axis, and FOV and SD may satisfy: 2.5 mm ⁻¹<Tan(FOV)/SD<3.5 mm⁻¹.

In an implementation mode, an effective focal length f3 of the third lens and an effective focal length f1 of the first lens may satisfy: 3.0f3/f1<5.0.

In an implementation mode, an effective focal length f6 of the sixth lens and an effective focal length f7 of the seventh lens may satisfy: −2.5<f6/f7<−1.58.

In an implementation mode, an effective focal length f4 of the fourth lens and a total effective focal length f of the optical imaging system may satisfy: −8.54<f4/f<−3.5.

In an implementation mode, a curvature radius R1 of the object-side surface of the first lens and, a curvature radius R2 of an image-side surface of the first lens may satisfy: 1.5<R2/R1<5.0.

In an implementation mode, a curvature radius R3 of an object-side surface of the second lens and a curvature radius R4 of an image-side surface of the second lens may satisfy: 0.5<R3/R4<2.0.

In an implementation mode, a curvature radius R11 of an object-side surface of the sixth lens and a curvature radius R12 of an image-side surface of the sixth lens may satisfy: −3.5<R12/R11<−1.0.

In an implementation mode, a spacing distance T12 between the first lens and the second lens on the optical axis and a spacing distance T23 between the second lens and the third lens on the optical axis satisfy: 1.5<T23/T12<4.0.

In an implementation mode, a center thickness CT1 of the first lens on the optical axis and a center thickness CT2 of the second lens on the optical axis satisfy: 3.0<CT1/CT2<5.0.

In an implementation mode, a center thickness CT3 of the third lens on the optical axis, a center thickness CT4 of the fourth lens on the optical axis and a spacing distance T34 between the third lens and the fourth lens on the optical axis may satisfy: 1.0<(CT3+CT4)/T34<3.0.

In an implementation mode, a spacing distance T45 between the fourth lens and the fifth lens on the optical axis, a spacing distance T56 between the fifth lens and the sixth lens on the optical axis and a center thickness CT5 of the fifth lens on the optical axis may satisfy: 2.5<(T45+T56)/CT5<3.5.

In an implementation mode, a center thickness CT6 of the sixth lens on the optical axis, a center thickness CT7 of the seventh lens on the optical axis and a spacing distance T67 between the sixth lens and the seventh lens on the optical axis may satisfy: 1.5<(CT6+CT7)/T67<3.1.

In an implementation mode, a maximum effective radius DT11 of the object-side surface of the first lens and a maximum effective radius DT32 of an image-side surface of the third lens may satisfy: 1.0<DT11/DT32<1.5.

In an implementation mode, the total effective focal length f of the optical imaging system and an Entrance Pupil Diameter (EPD) of the optical imaging system may satisfy: f/EP D<2.0.

Another embodiment of the disclosure provides an optical imaging system, the optical imaging system sequentially includes from an object side to an image side along an optical axis: a first lens with a positive refractive power; a second lens with a refractive power; a third lens with a refractive power; a diaphragm; a fourth lens with a negative refractive power; a fifth lens with a positive refractive power, an image-side surface thereof is a concave surface; a sixth lens with a refractive power, an image-side surface thereof is a convex surface; and a seventh lens with a refractive power. At least one mirror surface from an object-side surface of the first lens to an image-side surface of the seventh lens is an aspheric mirror surface. TTL is a distance from the object-side surface of the first lens to an imaging surface of the optical imaging system on the optical axis, ImgH is a half of a diagonal length of an effective pixel region on the imaging surface of the optical imaging system, and TTL and ImgH may satisfy: TTL/ImgH<1.2; and a spacing distance T45 between the fourth lens and the fifth lens on the optical axis, a spacing distance T56 between the fifth lens and the sixth lens on the optical axis and a center thickness CT5 of the fifth lens on the optical axis may satisfy: 2.5<(T45+T56)/CT5<3.5.

In an implementation mode, an effective focal length f3 of the third lens and an effective focal length f1 of the first lens may satisfy: 3.0<f3/f1<5.0.

In an implementation mode, an effective focal length f6 of the sixth lens and an effective focal length f7 of the seventh lens may satisfy: −2.5<f6/f7<−1.58.

In an implementation mode, an effective focal length f4 of the fourth lens and a total effective focal length f of the optical imaging system may satisfy: −8.54<f4/f<−3.5.

In an implementation mode, a curvature radius R1 of the object-side surface of the first lens and a curvature radius R2 of an image-side surface of the first lens may satisfy: 1.5<R2/R1<5.0.

In an implementation mode, a curvature radius R3 of an object-side surface of the second lens and a curvature radius R4 of an image-side surface of the second lens may satisfy: 0.5<R3/R4<2.0.

In an implementation mode, a curvature radius R11 of an object-side surface of the sixth lens and a curvature radius R12 of an image-side surface of the sixth lens may satisfy: −3.5<R12/R11<−1.0.

In an implementation mode, a spacing distance T12 between the first lens and the second lens on the optical axis and a spacing distance T23 between the second lens and the third lens on the optical axis satisfy: 1.5<T23/T12<4.0.

In an implementation mode, a center thickness CT1 of the first lens on the optical axis and a center thickness CT2 of the second lens on the optical axis satisfy:

3.0<CT1/CT2<5.0.

In an implementation mode, a center thickness CT3 of the third lens on the optical axis, a center thickness CT4 of the fourth lens on the optical axis and a spacing distance T34 between the third lens and the fourth lens on the optical axis may satisfy: 1.0<(CT3+CT4)/T34<3.0.

In an implementation mode, a center thickness CT6 of the sixth lens on the optical axis, a center thickness CT7 of the seventh lens on the optical axis and a spacing distance T67 between the sixth lens and the seventh lens on the optical axis may satisfy: 1.5<(CT6+CT7)/T67<3.1.

In an implementation mode, a maximum effective radius DT11 of the object-side surface of the first lens and a maximum effective radius DT32 of an image-side surface of the third lens may satisfy: 1.0<DT11/DT32<1.5.

In an implementation mode, the total effective focal length f of the optical imaging system and, an Entrance Pupil Diameter (EPD) of the optical imaging system may satisfy: f/EP D<2.0.

By reasonably distributing the refractive power and optimizing optical parameters, the disclosure provides an optical imaging system which is applicable to a portable electronic product and has at least one of beneficial effects of lightness and thinness, miniaturization, desirable imaging quality, etc.

### BRIEF DESCRIPTION OF THE DRAWINGS

Other features, objectives, and advantages of the disclosure will become more apparent by reading the detailed description on non-limiting embodiments made with reference to the following accompanying drawings:

FIG. 1 shows a structural schematic diagram of an optical imaging system according to Embodiment 1 of the disclosure;

FIGS. 2A-2C show a longitudinal aberration curve, an astigmatism curve and a distortion curve of the optical imaging system in Embodiment 1 respectively;

FIG. 3 shows a structural schematic diagram of an optical imaging system according to Embodiment 2 of the disclosure;

FIGS. 4A-4C show a longitudinal aberration curve, an astigmatism curve and a distortion curve of the optical imaging system in Embodiment 2 respectively;

FIG. 5 shows a structural schematic diagram of an optical imaging system according to Embodiment 3 of the disclosure;

FIGS. 6A-6C show a longitudinal aberration curve, an astigmatism curve and a distortion curve of the optical imaging system in Embodiment 3 respectively;

FIG. 7 shows a structural schematic diagram of an optical imaging system according to Embodiment 4 of the disclosure;

FIGS. 8A-8C show a longitudinal aberration curve, an astigmatism curve and a distortion curve of the optical imaging system in Embodiment 4 respectively;

FIG. 9 shows a structural schematic diagram of an optical imaging system according to Embodiment 5 of the disclosure;

FIGS. 10A-10C show a longitudinal aberration curve, an astigmatism curve and a distortion curve of the optical imaging system in Embodiment 5 respectively;

FIG. 11 shows a structural schematic diagram of an optical imaging system according to Embodiment 6 of the disclosure; and

FIGS. 12A-12C show a longitudinal aberration curve, an astigmatism curve and a distortion curve of the optical imaging system in Embodiment 6 respectively.

### DETAILED DESCRIPTION OF THE EMBODIMENTS

For understanding the disclosure better, more detailed descriptions will be made to each aspect of the disclosure with reference to the drawings. It is to be understood that these detailed descriptions are only descriptions about the exemplary embodiments of the disclosure and not intended to limit the scope of the disclosure in any manner. In the whole specification, the same reference sign numbers represent the same components. Expression “and/or” includes any or all combinations of one or more in associated items that are listed.

It should be noted that, in this description, the expressions of first, second, third, etc. are only used to distinguish one feature from another feature, and do not represent any limitation to the feature. Thus, a first lens discussed below could also be referred to as a second lens or a third lens without departing from the teachings of the disclosure.

In the drawings, the thickness, size and shape of the lens have been slightly exaggerated for ease of illustration. In particular, a spherical shape or an aspheric shape shown in the drawings is shown by some embodiments. That is, the spherical shape or the aspheric shape is not limited to the spherical shape or the aspheric shape shown in the drawings. The drawings are by way of example only and not strictly to scale.

Herein, a paraxial region refers to a region nearby an optical axis. If a lens surface is a convex surface and a position of the convex surface is not defined, it indicates that the lens surface is a convex surface at least in the paraxial region; and if the lens surface is a concave surface and a position of the concave surface is not defined, it indicates that the lens surface is a concave surface at least in the paraxial region. A surface of each lens closest to an object-side is called an object-side surface of the lens, and a surface of each lens closest to an imaging surface is called an image-side surface of the lens.

It also should be understood that terms “include”, “including”, “have”, “contain” and/or “containing”, used in this description, represent existence of a stated feature, component and/or part but do not exclude existence or addition of one or more other features, components and parts and/or combinations thereof. In addition, expressions like “at least one in . . . ” may appear after a list of listed features not to modify an individual component in the list but to modify the listed features. Moreover, when the implementation modes of the disclosure are described, “may” is used to represent “one or more implementation modes of the disclosure”. Furthermore, term “exemplary” refers to an example or exemplary description.

Unless otherwise defined, all terms (including technical terms and scientific terms) used in the disclosure have the same meanings usually understood by the general technical personnel in the field of the disclosure. It also should be understood that the terms (for example, terms defined in a common dictionary) should be explained to have meanings consistent with the meanings in the context of correlation technique and cannot be explained with ideal or excessively formal meanings, unless clearly defined like this in the disclosure.

It should be noted that the embodiments in the disclosure and features in the embodiments can be combined without conflicts. The disclosure will be described below with reference to the drawings and in combination with the embodiments in detail.

The features, principles and other aspects of the disclosure will be described below in detail.

The optical imaging system according to an exemplary embodiment of the disclosure may include seven lenses with refractive powers, which are a first lens, a second lens, a third lens, a fourth lens, a fifth lens, a sixth lens and a seventh lens respectively. The seven lenses are sequentially arranged from an object side to an image side along an optical axis. A spacing distance may be provided between any two adjacent lenses from the first lens to the seventh lens.

In an exemplary embodiment, the first lens may have a positive refractive power; the second lens may have a positive refractive power or a negative refractive power; the third lens may have a positive refractive or a negative refractive power; the fourth lens may have a negative refractive power; the fifth lens may have a positive refractive power, and an image-side surface thereof may be a concave surface; the sixth lens may have a positive refractive or a negative refractive power, and an image-side surface thereof may be a convex surface; and the seventh lens may have a positive refractive power or a negative refractive power.

In an exemplary embodiment, the optical imaging system may have small on-axis aberration by reasonably distributing the refractive powers of the first lens and the second lens, and the fifth lens and the sixth lens may effectively balance high order aberration of the system by reasonably distributing the refractive powers and surface types of the fifth lens and the sixth lens.

In an exemplary embodiment, the optical imaging system according to the disclosure may satisfy: 3.043/f1<5.0, wherein f3 is an effective focal length of the third lens and f1 is an effective focal length of the first lens. More specifically, and f3 and f1 may further satisfy: 3.0<f3/f1<4.7. In the case of satisfying 3.0<f3/f1 <5.0, the optical imaging system may better balance the aberration, and resolution of the system may be improved.

In an exemplary embodiment, the optical imaging system according to the disclosure may satisfy: −2.5<f6/f7<−1.58, wherein f6 is an effective focal length of the sixth lens and f7 is an effective focal length of the seventh lens. More specifically, and f6 and f7 may further satisfy: −2.2<f6/f7<−1.5. In the case of satisfying −2.5<f6/f7<−1.58, the optical imaging system may better balance the aberration, and the resolution of the system may be improved.

In an exemplary embodiment, the optical imaging system according to the disclosure may satisfy: −8.5f4/f<−3.5, wherein f4 is an effective focal length of the fourth lens and f is a total effective focal length of the optical imaging system. In the case of satisfying −8.5<f4/f<−3.5, a ghost image formed by total reflection of the fourth lens may be reduced, and a sensitivity of the fourth lens may also be reduced.

In an exemplary embodiment, the optical imaging system according to the disclosure may satisfy: 1.5<R2/R1<5.0, wherein R1 is a curvature radius of an object-side surface of the first lens, and R2 is a curvature radius of an image-side surface of the first lens. More specifically, R2 and R1 may further satisfy: 1.6<R2/R1<4.9. In the case of satisfying 1.5<R2/R1<5.0, a ghost image formed by total reflection in the first lens may be reduced.

In an exemplary embodiment, the optical imaging system according to the disclosure may satisfy: 0.5<R3/R4<2.0, wherein R3 is a curvature radius of an object-side surface of the second lens, and R4 is a curvature radius of an image-side surface of the second lens. More specifically, R3 and R4 may further satisfy: 0.8<R3/R4<2.0. In the case of satisfying 0.5<R3/R4<2.0, a sensitivity of the system may be reduced, and the second lens is guaranteed to have desirable manufacturability.

In an exemplary embodiment, the optical imaging system according to the disclosure may satisfy: −3.5<R12/R11<−1.0, wherein R11 is a curvature radius of an object-side surface of the sixth lens, and R12 is a curvature radius of an image-side surface of the sixth lens. More specifically, R12 and R11 may further satisfy: −3.1<R12/R11<−1.1. In the case of satisfying −3.5<R12/R11<−1.0, an included angle between main light incident to an image surface and the optical axis is reduced, and illumination of the image surface is improved.

In an exemplary embodiment, the optical imaging system according to the disclosure may satisfy: 1.5<T23/T12<4.0, wherein T12 is a spacing distance between the first lens and the second lens on the optical axis, and T23 is a spacing distance between the second lens and the third lens on the optical axis. More specifically, T23 and T12 may further satisfy: 1.7<T23/T12<3.8. In the case of satisfying 1.5<T23/T12<4.0, machining and assembling features of the optical imaging system may be ensured, the problems such as front-rear lenses interference caused by too small gaps between the lenses during an assembling process may be avoided, light deflection may also be relieved, field curvature of the optical imaging system may be adjusted, the sensitivity is reduced, and therefore, the optical imaging system may obtain better imaging quality.

In an exemplary embodiment, the optical imaging system according to the disclosure may satisfy: 3.0<CT1/CT2<5.0, wherein CT1 is a center thickness of the first lens on the optical axis, and CT2 is a center thickness of the second lens on the optical axis. More specifically, CT1 and CT2 may further satisfy: 3.1 <CT1/CT2<4.8. In the case of satisfying 3.0<CT1/CT2<5.0, the first lens and the second lens are easy to be injection-molded, the machinability of the optical imaging system is improved, and meanwhile it is guaranteed that the optical imaging system has the desirable imaging quality.

In an exemplary embodiment, the optical imaging system according to the disclosure may satisfy: 1.0<(CT3+CT4)/T34<3.0, wherein CT3 is a center thickness of the third lens on the optical axis, CT4 is a center thickness of the fourth lens on the optical axis, and T34 is a spacing distance between the third lens and the fourth lens on the optical axis. More specifically, CT3, CT4, and T34 may further satisfy: 1.3<(CT3+CT4)/T34<2.8. In the case of satisfying 1.0<(CT3+CT4)/T34<3.0, the system may have smaller field curvature.

In an exemplary embodiment, the optical imaging system according to the disclosure may satisfy: 2.5<(T45+T56)/CT5<3.5, wherein T45 is a spacing distance between the fourth lens and the fifth lens on the optical axis, T56 is a spacing distance between the fifth lens and the sixth lens on the optical axis, and CT5 is a center thickness of the fifth lens on the optical axis. More specifically, T45, T56 and CT5 may further satisfy: 2.7<(T45+T56)/CT5<3.3. In the case of satisfying 2.5<(T45+T56)/CT5<3.5, the optical imaging system may better balance the chromatic aberration of the system, the distortion of the system is effectively controlled, and the problems such as difficulty in the machining technology due to too thin the fifth lens may be effectively avoided.

In an exemplary embodiment, the optical imaging system according to the disclosure may satisfy: 1.5<(CT6+CT7)/T67<3.1, wherein CT6 is a center thickness of the sixth lens on the optical axis, CT7 is a center thickness of the seventh lens on the optical axis, and T67 is a spacing distance between the sixth lens and the seventh lens on the optical axis. More specifically, CT6, CT7, and T67 may further satisfy: 1.7<(CT6+CT7)/T67<3.1. In the case of satisfying 1.5<(CT6+CT7)/T67<3.1, a size of the optical imaging system may be effectively reduced, the size of the optical imaging system is prevented from being too large, assembly difficulty of each lens may also be reduced, and a high space utilization rate may be achieved.

In an exemplary embodiment, the optical imaging system according to the disclosure may satisfy: 1.0<DT11/DT32<1.5, wherein DT11 is a maximum effective radius of an object-side surface of the first lens, and DT32 is a maximum effective radius of an image-side surface of the third lens. More specifically, DT11 and DT32 may further satisfy: 1.1<DT11/DT32<1.5. In the case of satisfying 1.0<DT11/DT32<1.5, compactness of a structure of the optical imaging system is facilitated, it is guaranteed that the assembling process of the structure of the optical imaging system is relatively stable, and the problems that due to unreasonable effective radius distribution of the first lens and the third lens, caliber deviation between lenses is too large, assembling stress is not uniform, etc. may be avoided.

In an exemplary embodiment, the optical imaging system according to the disclosure may satisfy: TTL/ImgH<1.2, wherein TTL is a distance from an object-side surface of the first lens to an imaging surface of the optical imaging system on the optical axis, and ImgH is a half of a diagonal length of an effective pixel region on the imaging surface of the optical imaging system. In the case of satisfying TTL/ImgH<1.2, the ultrathin system may be achieved.

In an exemplary embodiment, the optical imaging system according to the disclosure may satisfy: 2.5 mm⁻¹<Tan(FOV)/SD<3.5 mm⁻¹, where FOV is a maximum field of view of the optical imaging system, and SD is a distance from a diaphragm to an image-side surface of the seventh lens on the optical axis. More specifically, FOV and SD may further satisfy: 2.8 mm⁻¹<Tan(FOV)/SD<3.2mm⁻¹. In the case of satisfying 2.5 mm⁻¹<Tan(FOV)/SD<3.5 mm, the optical imaging system may be guaranteed to have a reasonable image surface, and the optical imaging system may obtain a proper image information amount in a photographing process, such that imaging detail capability is more excellent.

In an exemplary embodiment, the optical imaging system according to the disclosure may satisfy: f/EPD<2.0, wherein f is a total effective focal length of the optical imaging system, and EPD is an Entrance Pupil Diameter of the optical imaging system. In the case of satisfying f/EPD<2.0, the optical imaging system may have a larger aperture, so as to increase a luminous flux of the system, to enhance an imaging effect in a dark environment, and further to reduce aberration of an edge field of view.

In an exemplary embodiment, the optical imaging system according to the disclosure further includes a diaphragm arranged between the third lens and the fourth lens. In an embodiment, the optical imaging system may further include an optical filter used for correcting color deviation and/or a protective glass used for protecting a photosensitive element located on the imaging surface. The disclosure provides an optical imaging system which has the features of miniaturization, ultra-thinness, high imaging quality etc. The optical imaging system according to the above-described embodiments of the disclosure may adopt multiple lenses, for example, the seven lenses described above. By reasonably distributing the refractive power and the surface types of each lens, the center thickness of each lens, the on-axis distance between the lenses, etc., incident light may be effectively converged, an optical total length of an imaging lens is reduced, the machinability of the imaging lens is improved, and accordingly, the optical imaging system is more easy to produce and machine.

In the embodiment of the disclosure, at least one of the mirror surfaces of all lenses is an aspheric mirror surface, that is, at least one mirror surface from an object-side surface of the first lens to an image-side surface of the seventh lens is an aspheric mirror surface. The aspheric lens has the features that the curvature varies continuously from a center of the lens to a periphery of the lens. Different from a spherical lens with a constant curvature from the center of the lens to the periphery of the lens, the aspheric lens has a better feature of a curvature radius and has the advantages of improving distortion aberration and astigmatism aberration. With the aspheric lens used, aberration occurring during imaging may be eliminated as much as possible, thereby improving the imaging quality. In an embodiment, at least one of the object-side surface and the image-side surface of each of the first lens, the second lens, the third lens, the fourth lens, the fifth lens, the sixth lens and the seventh lens is an aspheric mirror surface. In another embodiment, both of the object-side surface and the image-side surface of each of the first lens, the second lens, the third lens, the fourth lens, the fifth lens, the sixth lens and the seventh lens are aspheric mirror surfaces.

However, it should be understood by those skilled in the art that the number of lenses constituting the optical imaging lens group may be varied to obtain various results and advantages described in this specification without departing from the claimed technical solution. For example, although described with seven lenses as an example in an implementation mode, the optical imaging system is not limited to including seven lenses. The optical imaging system may also include other numbers of lenses if desired.

Specific embodiments of the optical imaging lens that may be suitable for use in the above embodiment are described further below with reference to the accompanying drawings.

### EMBODIMENT 1

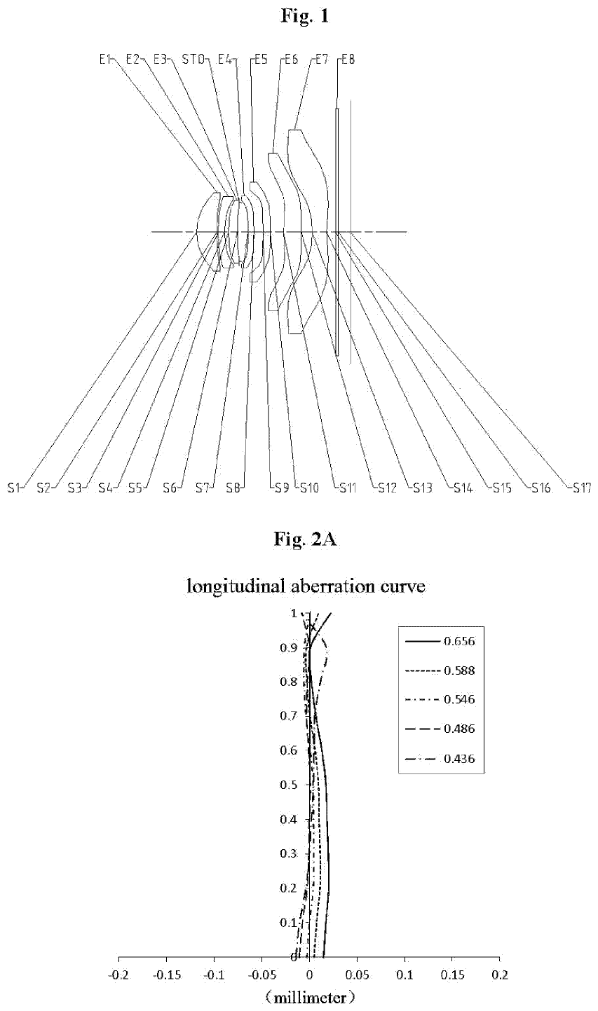

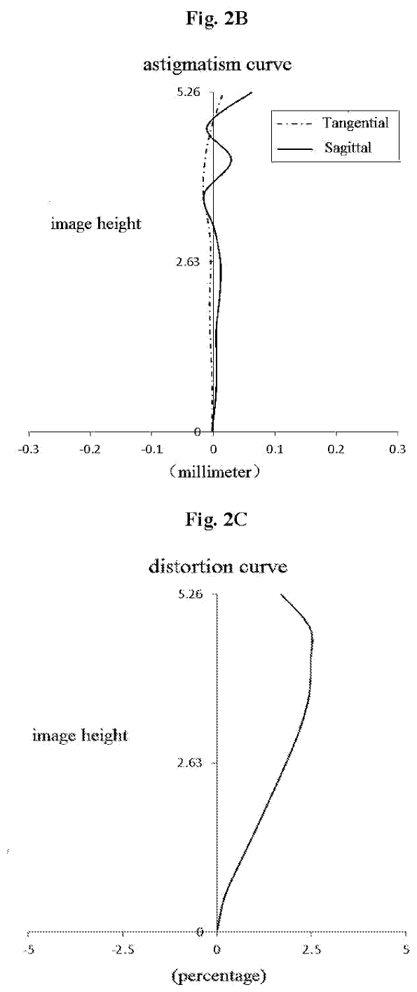

An optical imaging system according to Embodiment 1 of the disclosure is described below with reference to FIGS. 1-2C. FIG. 1 shows a structural schematic diagram of an optical imaging system according to Embodiment 1 of the disclosure.

As shown in FIG. 1, the optical imaging system sequentially includes from an object side to an image side: a first lens E1, a second lens E2, a third lens E3, a diaphragm STO, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, and an image-side surface S2 thereof is a concave surface. The second lens E2 has a negative refractive power, an object-side surface S3 thereof is a convex surface, and an image-side surface S4 thereof is a concave surface. The third lens E3 has a positive refractive power, an object-side surface S5 thereof is a convex surface, and an image-side surface S6 thereof is a concave surface. The fourth lens E4 has a negative refractive power, an object-side surface S7 thereof is a convex surface, and an image-side surface S8 thereof is a concave surface. The fifth lens E5 has a positive refractive power, an object-side surface S9 thereof is a convex surface, and an image-side surface S10 thereof is a concave surface. The sixth lens E6 has a positive refractive power, an object-side surface S11 thereof is a convex surface, and an image-side surface S12 thereof is a convex surface. The seventh lens E7 has a negative refractive power, an object-side surface S13 thereof is a concave surface, and an image-side surface S14 thereof is a concave surface. The optical filter E8 has an object-side surface S15 and an image-side surface S16. Light from an object sequentially passes through each of the surfaces from S1 to S16 and is finally imaged on the imaging surface S17.

Table 1 shows a table of basic parameters of the optical imaging system of Embodiment 1, wherein the units of the curvature radius, the thickness/distance and focal length are all millimeters (mm).

TABLE 1

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinity | Infinity | | | | |
| S1 | Aspheric | 1.9647 | 0.8100 | 1.55 | 56.1 | 4.8 | −0.0725 |
| S2 | Aspheric | 6.6886 | 0.0584 | | | | 3.5984 |
| S3 | Aspheric | 5.3961 | 0.2500 | 1.68 | 19.2 | −9.35 | −0.2806 |
| S4 | Aspheric | 2.8619 | 0.1695 | | | | −1.2561 |
| S5 | Aspheric | 4.9230 | 0.3571 | 1.57 | 37.4 | 14.44 | −14.1057 |
| S6(STO) | Aspheric | 11.9092 | 0.4288 | | | | 0.9978 |
| S7 | Aspheric | 269.1803 | 0.2300 | 1.68 | 19.2 | −46.96 | −0.2629 |
| S8 | Aspheric | 28.4971 | 0.3704 | | | | 96.5172 |
| S9 | Aspheric | 11.5426 | 0.2929 | 1.62 | 25.9 | 100.31 | −8.1885 |
| S10 | Aspheric | 14.0342 | 0.5321 | | | | 0.2441 |
| S11 | Aspheric | 6.2541 | 0.7195 | 1.55 | 56.1 | 7.54 | −0.1528 |
| S12 | Aspheric | −11.5882 | 0.4340 | | | | −0.1201 |
| S13 | Aspheric | −4.4791 | 0.5833 | 1.55 | 56.1 | −3.90 | −1.7287 |
| S14 | Aspheric | 4.2591 | 0.3681 | | | | 0.0107 |
| S15 | Spherical | Infinity | 0.1100 | 1.52 | 64.2 | | |
| S16 | Spherical | Infinity | 0.4860 | | | | |
| S17 | Spherical | Infinity | | | | | |

In this embodiment, f is a total effective focal length of the optical imaging lens, and f is 5.59 mm, TTL (that is, a distance from the object-side surface S1 of the first lens E1 to the imaging surface S17 of the optical imaging system on the optical axis) is a total length of the optical imaging system, and TTL is 6.20 mm, ImgH is a half of a diagonal length of an effective pixel region on the imaging surface S17 of the optical imaging system, and ImgH is 5.26 mm, Semi-FOV is a half of a maximum field of view of the optical imaging system, and Semi-FOV is 42.42°, DT11 is a maximum effective radius of the object-side surface of the first lens, and DT11 is 1.59 mm, DT32 is a maximum effective radius of the image-side surface of the third lens, and DT32 is 1.23 mm, and SD is a distance from the diaphragm to the image-side surface of the seventh lens on the optical axis, and SD is 3.59 mm.

In Embodiment 1, both of the object-side surface and the image-side surface of any one of the first lens E1 to the seventh lens E7 are aspheric surfaces, and the surface type x of each aspheric lens may be defined by, but is not limited to, the following aspheric formula:

$$x = \frac{{ch}^{2}}{1 + \sqrt{1 - ( k + 1 ) {c}^{2} {h}^{2}}} + \sum {Aih}^{i} \qquad ( 1 )$$

wherein x is a vector height of a distance between the aspheric surface and a vertex of the aspheric surface when the aspheric surface is located at a position with the height h in an optical axis direction; c is paraxial curvature of the aspheric surface, c=1/R (that is, the paraxial curvature c is an inverse of curvature radius R in Table 1 above); k is a conic coefficient; and Ai is a correction coefficient of the i-th order of the aspheric surface. Tables 2-1 and 2-2 below give high-order coefficients A4, A6, A8 A10 Al2, A14, A16, A18 A20, A22, A24, A26, A28 and A30 that may be used for each of the aspheric mirror surfaces S1-S14 in Embodiment 1.

TABLE 2-1

| Surface | | | | | | | |
|---|---|---|---|---|---|---|---|
| number | A4 | A6 | A8 | A10 | A12 | A14 | A16 |
| S1 | −3.2440E−02 | −1.5024E−02 | −4.9532E−03 | −1.0455E−03 | −1.0871E−04 | 5.4327E−05 | 2.9249E−05 |
| S2 | −2.7918E−02 | 1.0521E−03 | −1.1345E−03 | 1.0102E−03 | −2.7035E−04 | 1.2460E−04 | −3.5809E−05 |
| S3 | 4.6293E−03 | 1.3215E−02 | −1.3244E−03 | 9.9870E−04 | −4.3382E−04 | 9.1619E−05 | −5.0724E−05 |
| S4 | 4.7372E−02 | 1.1533E−02 | −1.0704E−03 | −3.4118E−04 | −5.4180E−04 | −1.4867E−04 | −5.8909E−05 |
| S5 | 7.0314E−02 | 1.7347E−02 | 4.1441E−03 | 8.9221E−04 | 3.6754E−05 | −3.0055E−05 | −1.9441E−05 |
| S6 | 3.8116E−03 | 5.7452E−03 | 1.6299E−03 | 5.1845E−04 | 1.3741E−04 | 4.4442E−05 | 8.7655E−06 |
| S7 | −2.0897E−01 | −1.7350E−02 | −3.2887E−03 | 2.6324E−05 | −1.1686E−04 | 4.0623E−05 | −6.3703E−05 |
| S8 | −3.1459E−01 | −1.1034E−02 | 3.2356E−03 | 4.4380E−03 | 1.2847E−03 | 5.4575E−04 | −4.4059E−05 |
| S9 | −5.8010E−01 | −3.2002E−02 | −1.1220E−02 | 8.8832E−03 | 6.1783E−03 | 4.2213E−03 | 1.5326E−03 |
| S10 | −7.3663E−01 | 8.9080E−02 | −2.0798E−02 | 2.0660E−03 | 1.6395E−03 | 1.6617E−03 | −4.5345E−04 |
| S11 | −1.5978E+00 | 3.3627E−01 | −1.5533E−02 | −1.2311E−02 | 1.8413E−02 | −1.0781E−02 | −3.2902E−03 |
| S12 | −6.7922E−01 | 1.0678E−01 | 4.4375E−02 | −2.6949E−02 | 3.7828E−02 | −1.2096E−02 | −3.9482E−03 |
| S13 | 2.2938E−01 | 4.0967E−01 | −2.4075E−01 | 9.0401E−02 | −2.0435E−02 | −2.8729E−03 | 7.4829E−03 |
| S14 | −4.4914E+00 | 6.5349E−01 | −2.2470E−01 | 5.2508E−02 | −5.6314E−02 | 8.4743E−03 | −3.9375E−04 |

TABLE 2-2

| Surface | | | | | | | |
|---|---|---|---|---|---|---|---|
| number | A18 | A20 | A22 | A24 | A26 | A28 | A30 |
| S1 | 9.1509E−06 | −2.3264E−06 | −2.4723E−07 | 0.0000E−00 | 0.0000E−00 | 0.0000E−00 | 0.0000E−00 |
| S2 | 6.5636E−06 | −4.99701E−06 | 0.0000E−00 | 0.0000E−00 | 0.0000E−00 | 0.0000E−00 | 0.0000E−00 |
| S3 | 1.9201E−07 | −4.4661E−06 | −4.2335E−09 | 0.0000E−00 | 0.0000E−00 | 0.0000E−00 | 0.0000E−00 |
| S4 | −1.0567E−05 | 2.5678E−07 | 0.0000E−00 | 0.0000E−00 | 0.0000E−00 | 0.0000E−00 | 0.0000E−00 |
| S5 | −5.5974E−06 | −1.8526E−07 | 0.0000E−00 | 0.0000E−00 | 0.0000E−00 | 0.0000E−00 | 0.0000E−00 |
| S6 | 4.5889E−06 | 7.4842E−08 | 0.0000E−00 | 0.0000E−00 | 0.0000E−00 | 0.0000E−00 | 0.0000E−00 |
| S7 | −2.2416E−05 | −2.4565E−05 | 6.7562E−06 | 0.0000E−00 | 0.0000E−00 | 0.0000E−00 | 0.0000E−00 |
| S8 | −6.9606E−05 | −7.0361E−05 | 0.0000E−00 | 0.0000E−00 | 0.0000E−00 | 0.0000E−00 | 0.0000E−00 |
| S9 | −9.0581E−05 | −4.8368E−04 | −3.5527E−04 | −1.4936E−04 | −3.6178E−05 | 0.0000E−00 | 0.0000E−00 |
| S10 | −3.9291E−04 | 3.2542E−04 | 2.0266E−04 | −2.9837E−05 | −6.4652E−05 | 0.0000E−00 | 0.0000E−00 |
| S11 | 3.8037E−03 | 1.1719E−03 | 1.6113E−03 | −2.6159E−04 | 4.2678E−04 | 6.8357E−05 | −6.8828E−05 |
| S12 | 1.6517E−05 | 1.1449E−03 | −3.6929E−04 | −4.0105E−04 | 4.7790E−05 | 7.8817E−05 | 1.41891E−05 |
| S13 | −5.0055E−03 | 7.9941E−04 | 1.3807E−03 | −1.12211E−03 | 1.9003E−05 | 1.6282E−04 | −9.978E−05 |
| S14 | 2.2432E−03 | −2.7737E−03 | −3.8585E−04 | −6.9190E−06 | 6.2896E−04 | −8.1470E−05 | −1.6421E−04 |

FIG. 2A shows a longitudinal aberration curve of the optical imaging system in Embodiment 1, which represents deviations of a convergence focal point after lights with different wavelengths passes through the lens. FIG. 2B shows an astigmatism curve of the optical imaging system of Embodiment 1, which represents a tangential image surface curvature and a sagittal image surface curvature. FIG. 2C shows a distortion curve of the optical imaging system of Embodiment 1, which represents distortion values corresponding to different image heights. FIGS. 2A-2C show that the optical imaging system provided in Embodiment 1 may achieve desirable imaging quality.

### EMBODIMENT 2

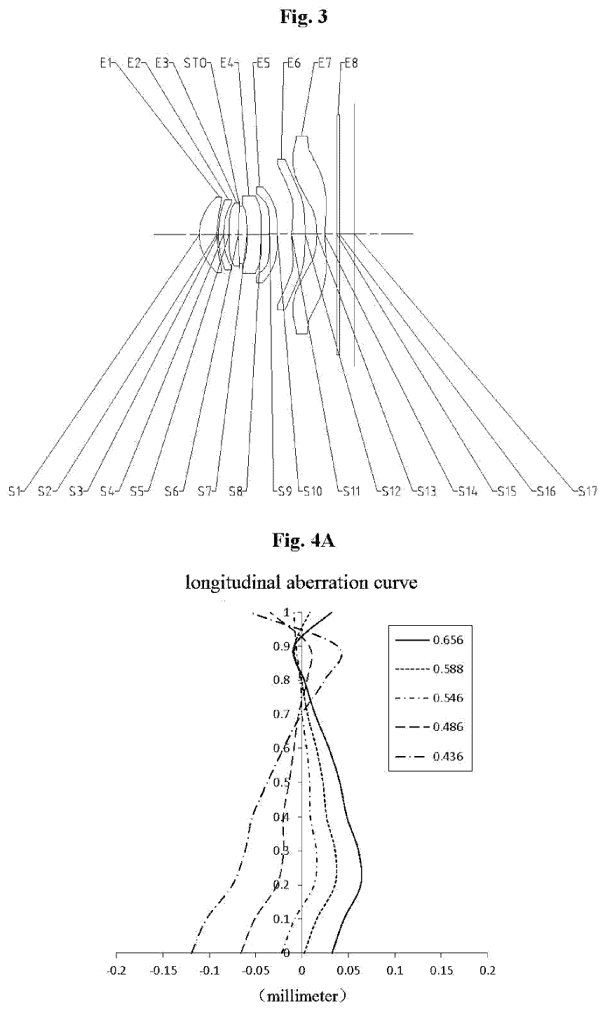

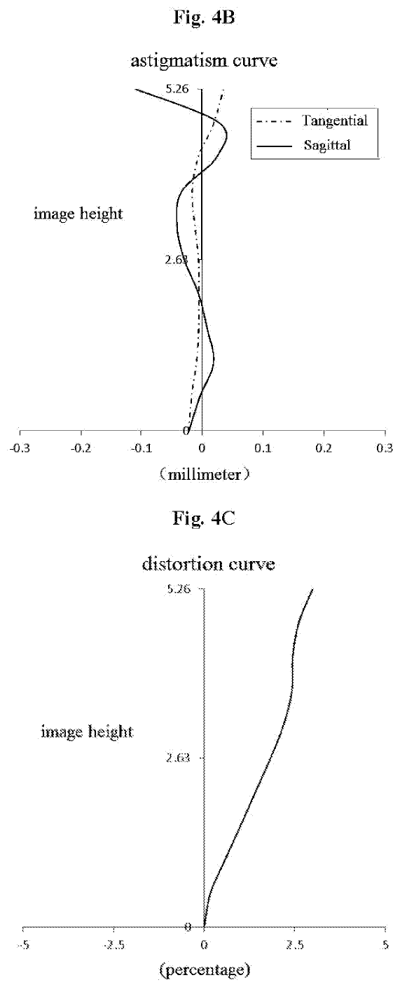

An optical imaging system according to Embodiment 2 of the disclosure is described below with reference to FIGS. 3-4C. In this and the following embodiments, parts of the description similar to Embodiment 1 will be omitted for the sake of brevity. FIG. 3 shows a structural schematic diagram of an optical imaging system according to Embodiment 2 of the disclosure.

As shown in FIG. 3, the optical imaging system sequentially includes from an object side to an image side: a first lens E1, a second lens E2, a third lens E3, a diaphragm STO, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, and an image-side surface S2 thereof is a concave surface. The second lens E2 has a positive refractive power, an object-side surface S3 thereof is a convex surface, and an image-side surface S4 thereof is a concave surface. The third lens E3 has a positive refractive power, an object-side surface S5 thereof is a convex surface, and an image-side surface S6 thereof is a concave surface. The fourth lens E4 has a negative refractive power, an object-side surface S7 thereof is a concave surface, and an image-side surface S8 thereof is a concave surface. The fifth lens E5 has a positive refractive power, an object-side surface S9 thereof is a convex surface, and an image-side surface S10 thereof is a concave surface. The sixth lens E6 has a positive refractive power, an object-side surface S11 thereof is a convex surface, and an image-side surface S12 thereof is a convex surface. The seventh lens E7 has a negative refractive power, an object-side surface S13 thereof is a concave surface, and an image-side surface S14 thereof is a concave surface. The optical filter E8 has an object-side surface S15 and an image-side surface S16. Light from an object sequentially passes through each of the surfaces from S1 to S16 and is finally imaged on the imaging surface S17.

In this embodiment, f is a total effective focal length of the optical imaging lens, and f is 5.53 mm, TTL is a total length of the optical imaging system, and TTL is 6.20 mm, ImgH is a half of a diagonal length of an effective pixel region on the imaging surface S17 of the optical imaging system, and ImgH is 5.26 mm, Semi-FOV is a half of a maximum field of view of the optical imaging system, and Semi-FOV is 42.32°, DT11 is a maximum effective radius of the object-side surface of the first lens, and DT11 is 1.54 mm, DT32 is a maximum effective radius of the image-side surface of the third lens, and DT32 is 1.26 mm, and SD is a distance from the diaphragm to the image-side surface of the seventh lens on the optical axis, and SD is 3.44 mm.

Table 3 shows a table of basic parameters of the optical imaging system of Embodiment 2, wherein the units of the curvature radius, the thickness/distance and focal length are all millimeters (mm). Tables 4-1 and 4-2 show high-order coefficients that may be used for each aspheric mirror surface in Embodiment 2, wherein each aspheric surface type may be defined by formula (1) given in Embodiment 1 above.

TABLE 3

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinity | Infinity | | | | |
| S1 | Aspheric | 1.8803 | 0.6995 | 1.55 | 56.1 | 7.07 | −0.0827 |
| S2 | Aspheric | 3.1796 | 0.0599 | | | | −2.4723 |
| S3 | Aspheric | 3.2277 | 0.2139 | 1.68 | 19.2 | 50 | −7.9580 |
| S4 | Aspheric | 3.4713 | 0.2206 | | | | 1.2216 |
| S5 | Aspheric | 11.4317 | 0.3738 | 1.57 | 37.4 | 30.17 | 52.0848 |
| S6(STO) | Aspheric | 33.6034 | 0.3507 | | | | 99.0000 |
| S7 | Aspheric | −18.2960 | 0.5656 | 1.68 | 19.2 | −19.66 | 99.0000 |
| S8 | Aspheric | 50.0000 | 0.3333 | | | | 36.2345 |
| S9 | Aspheric | 15.6706 | 0.3053 | 1.62 | 25.9 | 33.76 | −53.5055 |
| S10 | Aspheric | 61.8154 | 0.5760 | | | | −99.0000 |
| S11 | Aspheric | 5.5366 | 0.5356 | 1.55 | 56.1 | 5.58 | −2.3320 |
| S12 | Aspheric | −6.5614 | 0.4707 | | | | −19.4042 |
| S13 | Aspheric | −3.5280 | 0.3052 | 1.55 | 56.1 | −3.43 | −3.9287 |
| S14 | Aspheric | 4.1288 | 0.4S22 | | | | 0.0028 |
| S15 | Spherical | Infinity | 0.1100 | 1.52 | 64.2 | | |
| S16 | Spherical | Infinity | 0.5978 | | | | |
| S17 | Spherical | Infinity | | | | | |

TABLE 4-1

| Surface number | A4 | A6 | A8 | A10 | A12 | A14 | A16 |
|---|---|---|---|---|---|---|---|
| S1 | −3.2440E−02 | −1.5024E−02 | −4.9532E−03 | −1.0455E−03 | −1.0871E−04 | 5.4327E−05 | 2.9249E−05 |
| S2 | −7.5282E−02 | 7.6159E−03 | −5.5361E−04 | 3.2178E−04 | −1.0789E−04 | 4.2415E−07 | 3.0895E−05 |
| S3 | 4.6293E−03 | 1.3215E−02 | −1.3244E−03 | 9.9870E−04 | −4.3382E−04 | 9.1619E−05 | −5.0724E−05 |
| S4 | 6.1946E−02 | 5.1880E−03 | −2.2325E−03 | −2.2086E−04 | −2.9642E−04 | −9.4801E−05 | −3.1185E−05 |
| S5 | 7.8153E−02 | 1.9282E−02 | 3.8147E−03 | 8.4734E−04 | 6.5653E−05 | −5.1137E−05 | −1.5903E−05 |
| S6 | 3.8116E−03 | 5.7452E−03 | 1.6299E−03 | 5.1845E−04 | 1.3741E−04 | 4.4442E−05 | 8.7655E−06 |
| S7 | −2.0897E−01 | −1.7350E−02 | −3.2887E−03 | 2.6324E−05 | −1.1686E−04 | 4.0623E−05 | −6.3703E−05 |
| S8 | −2.4572E−01 | −4.2357E−04 | 1.8619E−03 | 2.6301E−03 | 3.8787E−04 | 2.7566E−04 | −1.0379E−05 |
| S9 | −5.8058E−01 | −2.4628E−02 | −7.0518E−03 | 9.2035E−03 | 5.7989E−03 | 3.9546E−03 | 1.6264E−03 |
| S10 | −7.3663E−01 | 8.9080E−02 | −2.0798E−02 | 2.0660E−03 | 1.6395E−03 | 1.6617E−03 | −4.5345E−04 |
| S11 | −1.5978E+00 | 3.3627E−01 | −1.5533E−02 | −1.2311E−02 | 1.8413E−02 | −1.0781E−02 | −3.2902E−03 |
| S12 | −5.0841E−01 | 1.2619E−01 | 2.5892E−02 | −3.8336E−02 | 4.3581E−02 | −9.7606E−03 | 2.3879E−03 |
| S13 | 2.2938E−01 | 4.0967E−01 | −2.4075E−01 | 9.0401E−02 | −2.0435E−02 | −2.8729E−03 | 7.4829E−03 |
| S14 | −4.3744E+00 | 7.1450E−01 | −2.3943E−01 | 2.4721E−02 | −7.7913E−02 | 8.5410E−03 | −1.7230E−03 |

TABLE 4-2

| Surface number | A18 | A20 | A22 | A24 | A26 | A28 | A30 |
|---|---|---|---|---|---|---|---|
| S1 | 9.1509E−06 | −2.3264E−06 | −2.4723E−07 | 0.0000E+00 | 0.0000E+00 | 0.0000E+00 | 0.0000E+00 |
| S2 | −1.3183E−05 | 1.7850E−06 | 0.0000E+00 | 0.0000E+00 | 0.0000E+00 | 0.0000E+00 | 0.0000E+00 |
| S3 | −1.9201E−07 | −4.4661E−06 | −4.2335E−09 | 0.0000E+00 | 0.0000E+00 | 0.0000E+00 | 0.0000E+00 |
| S4 | −7.3400E−06 | 9.3188E−06 | 0.0000E+00 | 0.0000E+00 | 0.0000E+00 | 0.0000E+00 | 0.0000E+00 |
| S5 | −2.3724E−05 | 5.0208E−06 | 0.0000E+00 | 0.0000E+00 | 0.0000E+00 | 0.0000E+00 | 0.0000E+00 |
| S6 | 4.5889E−06 | 7.4842E−08 | 0.0000E+00 | 0.0000E+00 | 0.0000E+00 | 0.0000E+00 | 0.0000E+00 |
| S7 | −2.2416E−05 | −2.4565E−05 | 6.7562E−06 | 0.0000E+00 | 0.0000E+00 | 0.0000E+00 | 0.0000E+00 |
| S8 | 7.0245E−06 | −1.5595E−05 | 0.0000E+00 | 0.0000E+00 | 0.0000E+00 | 0.0000E+00 | 0.0000E+00 |
| S9 | 1.6943E−04 | −3.0068E−04 | −2.5712E−04 | −1.3046E−04 | −3.3073E−05 | 0.0000E+00 | 0.0000E+00 |
| S10 | −3.9291E−04 | 3.2542E−04 | 2.0266E−04 | −2.9837E−05 | −6.4652E−05 | 0.0000E+00 | 0.0000E+00 |
| S11 | 3.8037E−03 | 1.1719E−03 | −1.6113E−03 | −2.6159E−04 | 4.2678E−04 | 6.8357E−05 | −6.8828E−05 |
| S12 | 6.6195E−03 | 2.9962E−03 | 2.0511E−04 | 1.1303E−03 | 1.4914E−03 | 5.4895E−04 | 1.1605E−04 |
| S13 | −5.0055E−03 | 7.9941E−04 | 1.3807E−03 | −1.1221E−03 | 1.9003E−04 | 1.6282E−04 | −9.9782E−05 |
| S14 | 3.0737E−03 | −2.9783E−03 | 1.4711E−04 | 1.0564E−03 | 1.8437E−03 | 8.4788E−04 | 2.9204E−04 |

FIG. 4A shows a longitudinal aberration curve of the optical imaging system in Embodiment 2, which represents deviations of a convergence focal point after lights with different wavelengths passes through the lens. FIG. 4B shows an astigmatism curve of the optical imaging system of Embodiment 2, which represents a tangential image surface curvature and a sagittal image surface curvature. FIG. 4C shows a distortion curve of the optical imaging system of Embodiment 2, which represents distortion values corresponding to different image heights. FIGS. 4A-4C show that the optical imaging system provided in Embodiment 2 may achieve desirable imaging quality.

### EMBODIMENT 3

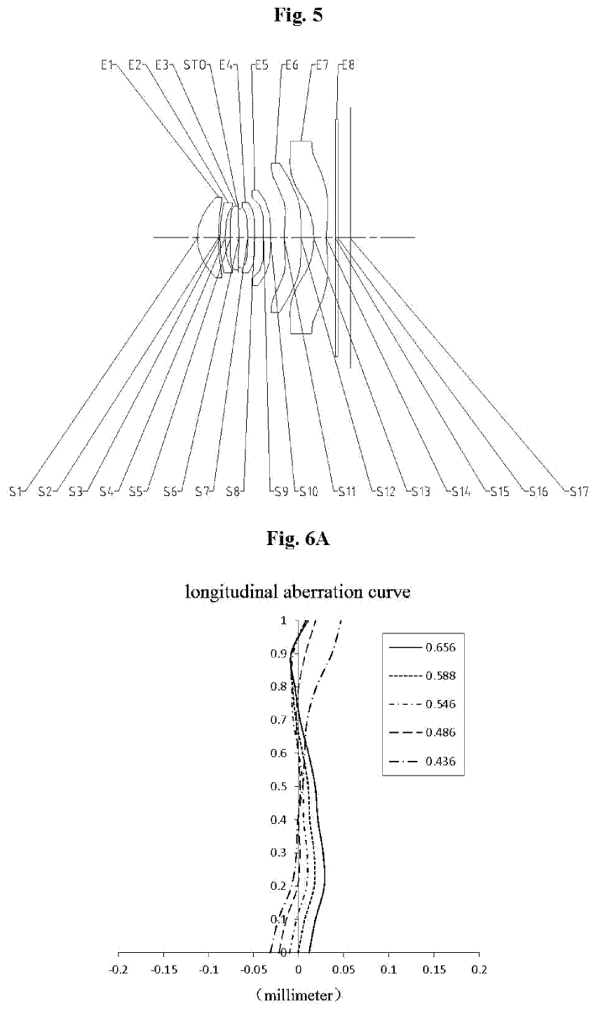

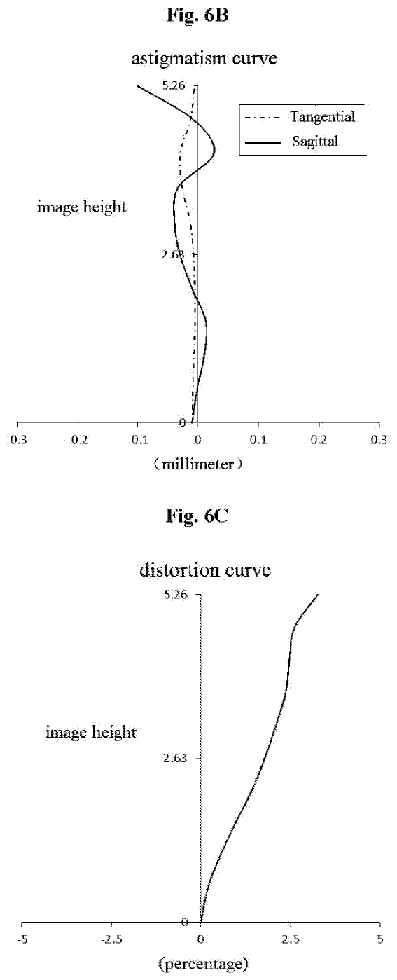

An optical imaging system according to Embodiment 3 of the disclosure is described below with reference to FIGS. 5-6C. FIG. 5 shows a structural schematic diagram of an optical imaging system according to Embodiment 3 of the disclosure.

As shown in FIG. 5, the optical imaging system sequentially includes from an object side to an image side: a first lens E1, a second lens E2, a third lens E3, a diaphragm STO, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, and an image-side surface S2 thereof is a concave surface. The second lens E2 has a negative refractive power, an object-side surface S3 thereof is a convex surface, and an image-side surface S4 thereof is a concave surface. The third lens E3 has a positive refractive power, an object-side surface S5 thereof is a convex surface, and an image-side surface S6 thereof is a convex surface. The fourth lens E4 has a negative refractive power, an object-side surface S7 thereof is a convex surface, and an image-side surface S8 thereof is a concave surface. The fifth lens E5 has a positive refractive power, an object-side surface S9 thereof is a convex surface, and an image-side surface S10 thereof is a concave surface. The sixth lens E6 has a positive refractive power, an object-side surface S11 thereof is a convex surface, and an image-side surface S12 thereof is a convex surface. The seventh lens E7 has a negative refractive power, an object-side surface S13 thereof is a concave surface, and an image-side surface S14 thereof is a concave surface. The optical filter E8 has an object-side surface S15 and an image-side surface S16. Light from an object sequentially passes through each of the surfaces from S1 to S16 and is finally imaged on the imaging surface S17.

In this embodiment, f is a total effective focal length of the optical imaging lens, and f is 5.53 mm, TTL is a total length of the optical imaging system, and TTL is 6.20 mm, ImgH is a half of a diagonal length of an effective pixel region on the imaging surface S17 of the optical imaging system, and ImgH is 5.26 mm, Semi-FOV is a half of a maximum field of view of the optical imaging system, and Semi-FOV is 42.26°, DT11 is a maximum effective radius of the object-side surface of the first lens, and DT11 is 1.72 mm, DT32 is a maximum effective radius of the image-side surface of the third lens, and DT32 is 1.26 mm, and SD is a distance from the diaphragm to the image-side surface of the seventh lens on the optical axis, and SD is 3.54 mm.

Table 5 shows a table of basic parameters of the optical imaging system of Embodiment 3, wherein the units of the curvature radius, the thickness/distance and focal length are all millimeters (mm). Tables 6-1 and 6-2 show high-order coefficients that may be used for each aspheric mirror surface in Embodiment 3, wherein each aspheric surface type may be defined by formula (1) given in Embodiment 1 above.

TABLE 5

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinity | Infinity | | | | |
| S1 | Aspheric | 1.9776 | 0.8546 | 1.55 | 156.1 | 4.7 | −0.0631 |
| 82 | Aspheric | 7.2635 | 0.0687 | | | | 1.5248 |
| S3 | Aspheric | 7.5186 | 0.2000 | 1.68 | 19.2 | −12.64 | 1.5442 |
| S4 | Aspheric | 3.9644 | 0.2170 | | | | −0.1442 |
| S5 | Aspheric | 43.6172 | 0.3472 | 1.57 | 37.4 | 21.68 | −99.0000 |
| S6(STO) | Aspheric | −17.2257 | 0.3506 | | | | −99.0000 |
| S7 | Aspheric | 77.2600 | 0.2753 | 1.68 | 19.2 | −32.23 | −99.0000 |
| S8 | Aspheric | 17.0267 | 0.3682 | | | | 91.1558 |
| S9 | Aspheric | 12.6641 | 0.2859 | 1.62 | 25.9 | 95.92 | 14.8838 |
| S10 | Aspheric | 15.9500 | 0.5496 | | | | 15.0598 |
| S11 | Aspheric | 5.5322 | 0.6871 | 1.55 | 56.1 | 7.32 | −0.0093 |
| S12 | Aspheric | −13.8169 | 0.5189 | | | | −1.3110 |
| S13 | Aspheric | −4.3236 | 0.5013 | 1.55 | 56.1 | −3.83 | −2.1436 |
| S14 | Aspheric | 4.2135 | 0.3737 | | | | 0.0154 |
| S15 | Spherical | Infinity | 0.1100 | 1.52 | 64.2 | | |
| S16 | Spherical | Infinity | 0.4917 | | | | |
| S17 | Spherical | Infinity | | | | | |

TABLE 6-1

| Surface | | | | | | | |
|---|---|---|---|---|---|---|---|
| number | A4 | A6 | A8 | A10 | A12 | A14 | A16 |
| S1 | −3.2440E−02 | −1.5024E−02 | −4.9532E−03 | −1.0455E−03 | −1.0871E−04 | 5.4327E−05 | 2.9249E−05 |
| S2 | −3.2589E−02 | 5.3809E−03 | −6.4063E−04 | 7.2347E−04 | −6.6087E−05 | 3.5418E−05 | 1.3892E−05 |
| S3 | 4.6293E−03 | 1.3215E−02 | −1.3244E−03 | 9.9870E−04 | −4.3382E−04 | 9.1619E−05 | −5.0724E−05 |
| S4 | 5.3349E−02 | 9.8428E−03 | 6.4789E−04 | 4.1601E−04 | −3.6334E−04 | −1.5964E−04 | −1.1022E−04 |
| S5 | 6.3186E−02 | 1.9046E−02 | 5.3511E−03 | 1.2799E−03 | 1.3325E−04 | −7.5868E−05 | −5.3765E−05 |
| S6 | 3.8116E−03 | 5.7452E−03 | 1.6299E−03 | 5.1845E−04 | 1.3741E−04 | 4.4442E−05 | 8.7655E−06 |
| S7 | −2.0897E−01 | −1.7350E−02 | −3.2887E−03 | 2.6324E−05 | −1.1686E−04 | 4.0623E−05 | −6.3703E−05 |
| S8 | −3.1043E−01 | −1.1580E−02 | 3.2776E−03 | 4.4152E−03 | 1.4741E−03 | 7.9254E−04 | 1.8706E−04 |
| S9 | −5.6476E−01 | −2.5949E−02 | −7.1446E−03 | 9.9356E−03 | 5.7903E−03 | 3.8338E−03 | 1.5907E−03 |
| S10 | −7.3663E−01 | 8.9080E−02 | −2.0798E−02 | 2.0660E−03 | 1.6395E−03 | 1.6617E−03 | −4.5345E−04 |
| S11 | −1.5978E+00 | 3.3627E−01 | −1.5533E−02 | −1.2311E−02 | 1.8413E−02 | −1.0781E−02 | −3.2902E−03 |
| S12 | −6.7463E−01 | 8.7301E−02 | 3.4279E−02 | −1.4168E−02 | 4.0934E−02 | −1.4989E−02 | −6.3825E−03 |
| S13 | 2.2938E−01 | 4.0967E−01 | −2.4075E−01 | 9.0401E−02 | −2.0435E−02 | −2.8729E−03 | 7.4829E−03 |
| S14 | −4.1999E+00 | 7.0553E−01 | −2.4273E−01 | 3.3154E−02 | −5.9435E−02 | 9.3133E−03 | −1.3787E−03 |

TABLE 6-2

| Surface | | | | | | | |
|---|---|---|---|---|---|---|---|
| number | A18 | A20 | A22 | A24 | A26 | A28 | A30 |
| S1 | 9.1509E−06 | −2.3264E−06 | −2.4723E−07 | 0.0000E+00 | 0.0000E+00 | 0.0000E+00 | 0.0000E+00 |
| S2 | −2.0682E−05 | 9.7184E−06 | 0.0000E+00 | 0.0000E+00 | 0.0000E+00 | 0.0000E+00 | 0.0000E+00 |
| S3 | −1.9201E−07 | −4.4661E−06 | −4.2335E−09 | 0.0000E+00 | 0.0000E+00 | 0.0000E+00 | 0.0000E+00 |
| S4 | −2.9087E−05 | 2.3547E−06 | 0.0000E+00 | 0.0000E+00 | 0.0000E+00 | 0.0000E+00 | 0.0000E+00 |
| S5 | −3.7350E−05 | −3.4209E−06 | 0.0000E+00 | 0.0000E+00 | 0.0000E+00 | 0.0000E+00 | 0.0000E+00 |
| S6 | 4.5889E−06 | 7.4842E−08 | 0.0000E+00 | 0.0000E+00 | 0.0000E+00 | 0.0000E+00 | 0.0000E+00 |
| S7 | −2.2416E−05 | −2.4565E−05 | 6.7562E−06 | 0.0000E+00 | 0.0000E+00 | 0.0000E+00 | 0.0000E+00 |
| S8 | 6.5417E−05 | −1.7901E−05 | 0.0000E+00 | 0.0000E+00 | 0.0000E+00 | 0.0000E+00 | 0.0000E+00 |
| S9 | 1.4847E−04 | −3.0192E−04 | −2.9320E−04 | −1.5873E−04 | −5.9128E−05 | 0.0000E+00 | 0.0000E+00 |
| S10 | −3.9291E−04 | 3.2542E−04 | 2.0266E−04 | −2.9837E−05 | −6.4652E−05 | 0.0000E+00 | 0.0000E+00 |
| S11 | 3.8037E−03 | 1.1719E−03 | −1.6113E−03 | −2.6159E−04 | 4.2678E−04 | 6.8357E−05 | −6.8828E−05 |
| S12 | −2.7248E−03 | −1.5912E−03 | −1.9752E−03 | −1.2129E−03 | −2.2331E−04 | 4.8038E−05 | 8.6735E−05 |
| S13 | −5.0055E−03 | 7.9941E−04 | 1.3807E−03 | −1.1221E−03 | 1.9003E−04 | 1.6282E−04 | −9.9782E−05 |
| S14 | 2.0846E−03 | −1.4753E−03 | 7.6040E−04 | 1.0818E−03 | 1.0609E−03 | 4.8680E−05 | −3.5281E−04 |

FIG. 6A shows a longitudinal aberration curve of the optical imaging system in Embodiment 3, which represents deviations of a convergence focal point after lights with different wavelengths passes through the lens. FIG. 6B shows an astigmatism curve of the optical imaging system of Embodiment 3, which represents a tangential image surface curvature and a sagittal image surface curvature. FIG. 6C shows a distortion curve of the optical imaging system of Embodiment 3, which represents distortion values corresponding to different image heights. FIGS. 6A-6C show that the optical imaging system provided in Embodiment 3 may achieve desirable imaging quality.

### EMBODIMENT 4

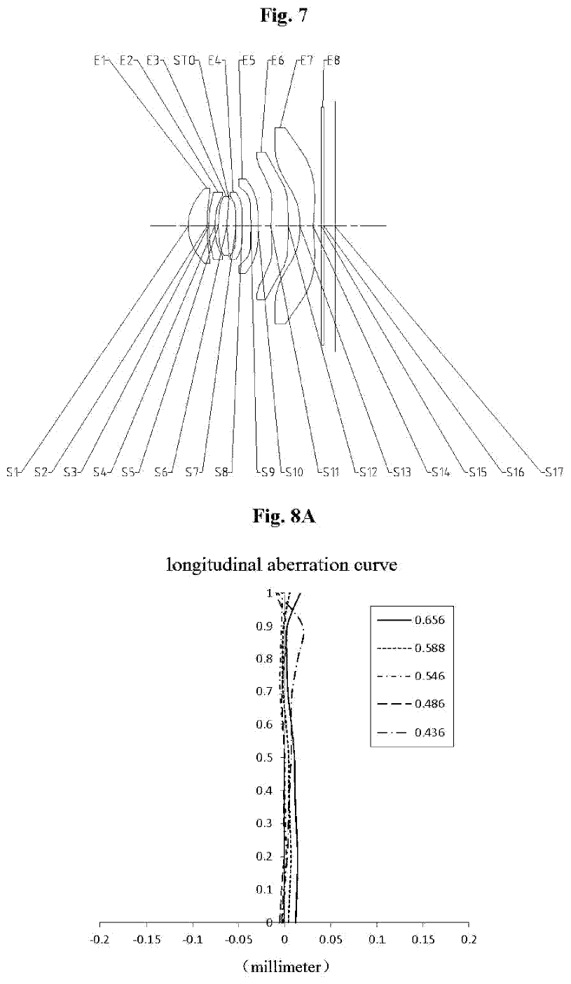

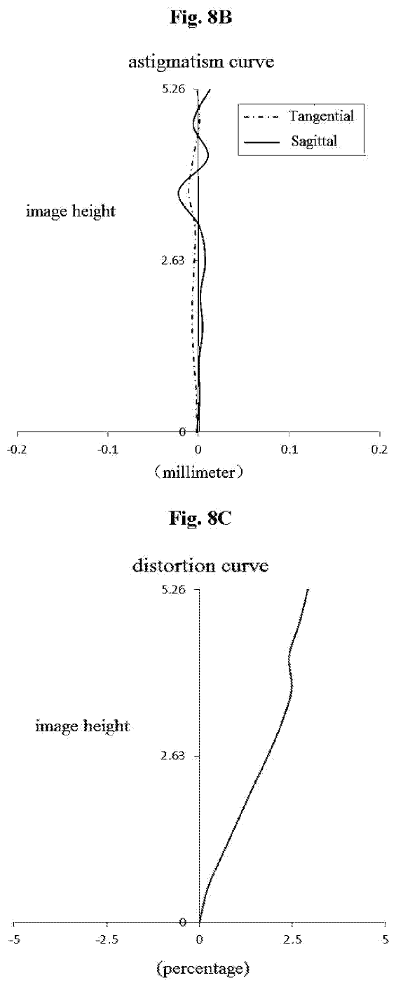

An optical imaging system according to Embodiment 4 of the disclosure is described below with reference to FIGS. 7-8C. FIG. 7 shows a structural schematic diagram of an optical imaging system according to Embodiment 4 of the disclosure.

As shown in FIG. 7, the optical imaging system sequentially includes from an object side to an image side: a first lens E1, a second lens E2, a third lens E3, a diaphragm STO, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, and an image-side surface S2 thereof is a concave surface. The second lens E2 has a negative refractive power, an object-side surface S3 thereof is a convex surface, and an image-side surface S4 thereof is a concave surface. The third lens E3 has a positive refractive power, an object-side surface S5 thereof is a convex surface, and an image-side surface S6 thereof is a concave surface. The fourth lens E4 has a negative refractive power, an object-side surface S7 thereof is a concave surface, and an image-side surface S8 thereof is a concave surface. The fifth lens E5 has a positive refractive power, an object-side surface S9 thereof is a convex surface, and an image-side surface S10 thereof is a concave surface. The sixth lens E6 has a positive refractive power, an object-side surface S11 thereof is a convex surface, and an image-side surface S12 thereof is a convex surface. The seventh lens E7 has a negative refractive power, an object-side surface S13 thereof is a concave surface, and an image-side surface S14 thereof is a concave surface. The optical filter E8 has an object-side surface S15 and an image-side surface S16. Light from an object sequentially passes through each of the surfaces from S1 to S16 and is finally imaged on the imaging surface S17.

In this embodiment, f is a total effective focal length of the optical imaging lens, and f is 5.55 mm, TTL is a total length of the optical imaging system, and TTL is 6.20 mm, ImgH is a half of a diagonal length of an effective pixel region on the imaging surface S17 of the optical imaging system, and ImgH is 5.26 mm, Semi-FOV is a half of a maximum field of view of the optical imaging system, and Semi-FOV is 42.30°, DT11 is a maximum effective radius of the object-side surface of the first lens, and DT11 is 1.60 mm, DT32 is a maximum effective radius of the image-side surface of the third lens, and DT32 is 1.21 mm, and SD is a distance from the diaphragm to the image-side surface of the seventh lens on the optical axis, and SD is 3.64 mm.

Table 7 shows a table of basic parameters of the optical imaging system of Embodiment 4, wherein the units of the curvature radius, the thickness/distance and focal length are all millimeters (mm). Tables 8-1 and 8-2 show high-order coefficients that may be used for each aspheric mirror surface in Embodiment 4, wherein each aspheric surface type may be defined by formula (1) given in Embodiment 1 above.

TABLE 7

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinity | Infinity | | | | |
| S1 | Aspheric | 1.9701 | 0.8012 | 1.55 | 56.1 | 4.61 | −0.0801 |
| S2 | Aspheric | 7.7477 | 0.0730 | | | | 3.9542 |
| S3 | Aspheric | 5.5079 | 0.2467 | 1.68 | 19.2 | −8.72 | 0.5721 |
| S4 | Aspheric | 2.8023 | 0.1555 | | | | −1.4317 |
| S5 | Aspheric | 4.6553 | 0.3625 | 1.57 | 37.4 | 15.43 | −15.0442 |
| S6(STO) | Aspheric | 9.5983 | 0.3850 | | | | −2.4929 |
| S7 | Aspheric | −35.0000 | 0.2683 | 1.68 | 19.2 | −37.05 | −95.3671 |
| S8 | Aspheric | 89.6813 | 0.3567 | | | | 99.0000 |
| S9 | Aspheric | 9.8156 | 0.2963 | 1.62 | 25.9 | 80.07 | −7.2226 |
| S10 | Aspheric | 12.0923 | 0.5490 | | | | −6.1183 |
| S11 | Aspheric | 6.0474 | 0.7421 | 1.55 | 56.1 | 7.25 | −0.5141 |
| S12 | Aspheric | −11.0108 | 0.4885 | | | | 0.9679 |
| S13 | Aspheric | −4.3878 | 0.5568 | 1.55 | 56.1 | −3.86 | −1.7624 |
| S14 | Aspheric | 4.2517 | 0.3483 | | | | 0.0087 |
| S15 | Spherical | Infinity | 0.1100 | 1.53 | 64.2 | | |
| S16 | Spherical | Infinity | 0.4600 | | | | |
| S17 | Spherical | Infinity | | | | | |

TABLE 8-1

| Surface | | | | | | | |
|---|---|---|---|---|---|---|---|
| number | A4 | A6 | A8 | A10 | A12 | A14 | A16 |
| S1 | −3.2440E−02 | −1.5024E−02 | −4.9532E−03 | −1.0455E−03 | −1.0871E−04 | 5.4327E−05 | 2.9249E−05 |
| S2 | −2.6585E−02 | −3.5030E−05 | −1.2879E−03 | 9.1381E−04 | −2.6632E−04 | 1.1876E−04 | −3.9368E−05 |
| S3 | 4.6293E−03 | 1.3215E−02 | −1.3244E−03 | 9.9870E−04 | −4.3382E−04 | 9.1619E−05 | −5.0724E−05 |
| S4 | 4.4953E−02 | 1.2239E−02 | −1.4716E−03 | −5.0366E−04 | −7.6431E−04 | −2.1905E−04 | −8.4765E−05 |
| S5 | 6.9452E−02 | 1.7242E−02 | 4.0584E−03 | 7.8557E−04 | −8.7572E−05 | −8.1870E−05 | −3.5434E−05 |
| S6 | 3.8116E−03 | 5.7452E−03 | 1.6299E−03 | 5.1845E−04 | 1.3741E−04 | 4.4442E−05 | 8.7655E−06 |
| S7 | −2.0897E−01 | −1.7350E−02 | −3.2887E−03 | 2.6324E−05 | −1.1686E−04 | 4.0623E−05 | −6.3703E−05 |
| S8 | −2.9334E−01 | −5.0385E−03 | 4.3951E−03 | 4.8896E−03 | 1.5997E−03 | 7.9217E−04 | 1.1757E−04 |
| S9 | −5.8210E−01 | −3.0066E−02 | −1.0910E−02 | 8.8972E−03 | 6.8066E−03 | 4.8989E−03 | 2.0042E−03 |
| S10 | −7.3663E−01 | 8.9080E−02 | −2.0798E−02 | 2.0660E−03 | 1.6395E−03 | 1.6617E−03 | −4.5345E−04 |
| S11 | −1.5978E+00 | 3.3627E−01 | −1.5533E−02 | −1.2311E−02 | 1.8413E−02 | −1.0781E−02 | −3.2902E−03 |
| S12 | −6.8989E−01 | 1.2128E−01 | 4.9660E−02 | −3.0000E−02 | 3.8350E−02 | −1.0535E−02 | −5.2424E−03 |
| S13 | 2.2938E−01 | 4.0967E−01 | −2.4075E−01 | 9.0401E−02 | −2.0435E−02 | −2.8729E−03 | 7.4829E−03 |
| S14 | −4.5883E+00 | 5.6850E−01 | −2.1357E−01 | 6.0030E−02 | −5.6244E−02 | 3.0882E−03 | −1.0474E−03 |

TABLE 8-2

| Surface | | | | | | | |
|---|---|---|---|---|---|---|---|
| number | A18 | A20 | A22 | A24 | A26 | A28 | A30 |
| S1 | 9.1509E−06 | −2.3264E−06 | −2.4723E−07 | 0.0000E+00 | 0.0000E+00 | 0.0000E+00 | 0.0000E+00 |
| S2 | 9.7887E−06 | −6.7517E−06 | 0.0000E+00 | 0.0000E+00 | 0.0000E+00 | 0.0000E+00 | 0.0000E+00 |
| S3 | −1.9201E−07 | −4.4661E−06 | −4.2335E−09 | 0.0000E+00 | 0.0000E+00 | 0.0000E+00 | 0.0000E+00 |
| S4 | −1.6493E−05 | −4.1167E−07 | 0.0000E+00 | 0.0000E+00 | 0.0000E+00 | 0.0000E+00 | 0.0000E+00 |
| S5 | −1.1058E−05 | −1.7639E−06 | 0.0000E+00 | 0.0000E+00 | 0.0000E+00 | 0.0000E+00 | 0.0000E+00 |
| S6 | 4.5889E−06 | 7.4842E−08 | 0.0000E+00 | 0.0000E+00 | 0.0000E+00 | 0.0000E+00 | 0.0000E+00 |
| S7 | −2.2416E−05 | −2.4565E−05 | 6.7562E−06 | 0.0000E+00 | 0.0000E+00 | 0.0000E+00 | 0.0000E+00 |
| S8 | 1.0641E−05 | −3.6151E−05 | 0.0000E+00 | 0.0000E+00 | 0.0000E+00 | 0.0000E+00 | 0.0000E+00 |
| S9 | 3.0726E−05 | −5.6517E−04 | −4.9676E−04 | −2.4058E−04 | −7.9022E−05 | 0.0000E+00 | 0.0000E+00 |
| S10 | −3.9291E−04 | 3.2542E−04 | 2.0266E−04 | −2.9837E−05 | −6.4652E−05 | 0.0000E+00 | 0.0000E+00 |
| S11 | 3.8037E−03 | 1.1719E−03 | −1.6113E−03 | −2.6159E−04 | 4.2678E−04 | 6.8357E−05 | −6.8828E−05 |
| S12 | 2.0828E−04 | 1.9491E−03 | −1.6063E−04 | −5.4427E−04 | 6.3257E−05 | 1.4970E−04 | −1.7944E−05 |
| S13 | −5.0055E−03 | 7.9941E−04 | 1.3807E−03 | −1.1221E−03 | 1.9003E−04 | 1.6282E−04 | −9.9782E−05 |
| S14 | 2.7452E−03 | −2.4383E−03 | −1.0358E−03 | −1.2317E−05 | 7.9736E−04 | −1.3905E−04 | −2.9570E−04 |

FIG. 8A shows a longitudinal aberration curve of the optical imaging system in Embodiment 4, which represents deviations of a convergence focal point after lights with different wavelengths passes through the lens. FIG. 8B shows an astigmatism curve of the optical imaging system of Embodiment 4, which represents a tangential image surface curvature and a sagittal image surface curvature. FIG. 8C shows a distortion curve of the optical imaging system of Embodiment 4, which represents distortion values corresponding to different image heights. FIGS. 8A-8C show that the optical imaging system provided in Embodiment 4 may achieve desirable imaging quality.

### EMBODIMENT 5

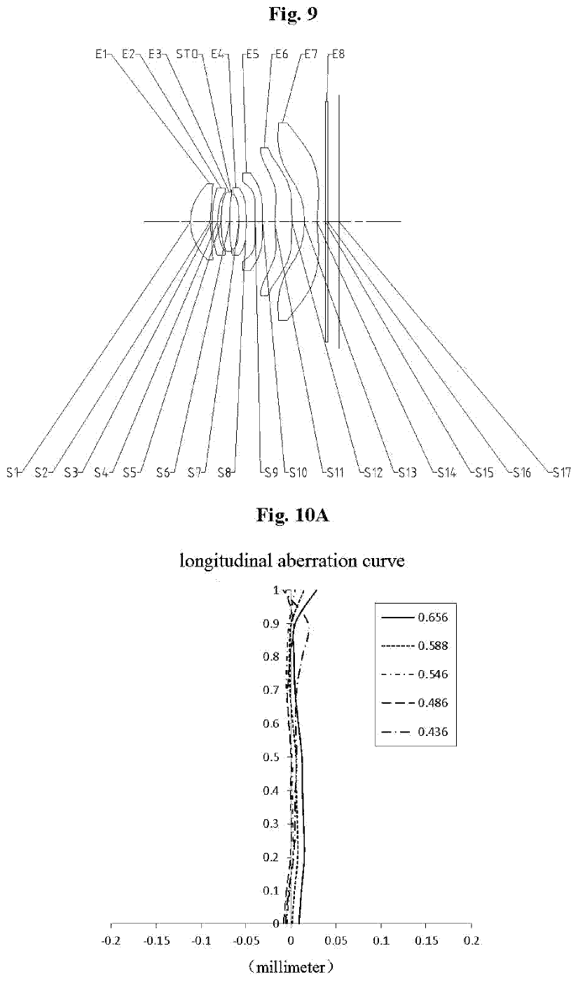

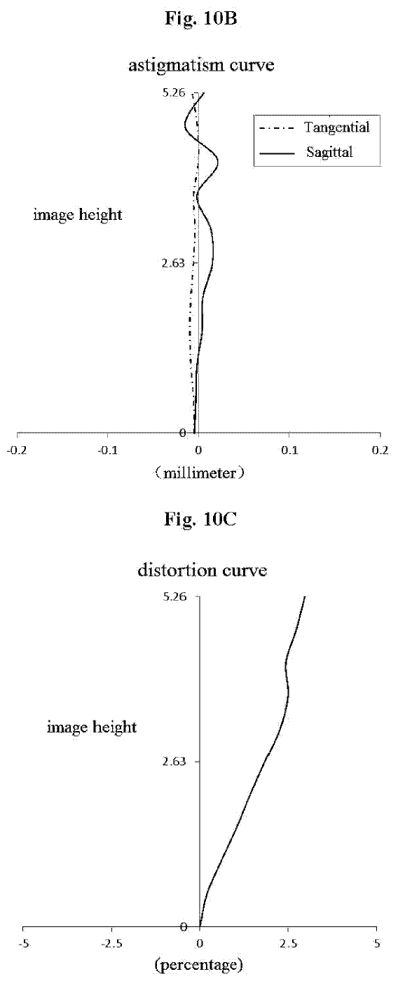

An optical imaging system according to Embodiment 5 of the disclosure is described below with reference to FIGS. 9-10C. FIG. 9 shows a structural schematic diagram of an optical imaging system according to Embodiment 5 of the disclosure.

As shown in FIG. 9, the optical imaging system sequentially includes from an object side to an image side: a first lens E1, a second lens E2, a third lens E3, a diaphragm STO, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, and an image-side surface S2 thereof is a concave surface. The second lens E2 has a negative refractive power, an object-side surface S3 thereof is a convex surface, and an image-side surface S4 thereof is a concave surface. The third lens E3 has a positive refractive power, an object-side surface S5 thereof is a convex surface, and an image-side surface S6 thereof is a concave surface. The fourth lens E4 has a negative refractive power, an object-side surface S7 thereof is a concave surface, and an image-side surface S8 thereof is a convex surface. The fifth lens E5 has a positive refractive power, an object-side surface S9 thereof is a convex surface, and an image-side surface S10 thereof is a concave surface. The sixth lens E6 has a positive refractive power, an object-side surface S11 thereof is a convex surface, and an image-side surface S12 thereof is a convex surface. The seventh lens E7 has a negative refractive power, an object-side surface S13 thereof is a concave surface, and an image-side surface S14 thereof is a concave surface. The optical filter E8 has an object-side surface S15 and an image-side surface S16. Light from an object sequentially passes through each of the surfaces from S1 to S16 and is finally imaged on the imaging surface S17.

In this embodiment, f is a total effective focal length of the optical imaging lens, and f is 5.55 mm, TTL is a total length of the optical imaging system, and TTL is 6.20 mm, ImgH is a half of a diagonal length of an effective pixel region on the imaging surface S17 of the optical imaging system, and ImgH is 5.26 mm, Semi-FOV is a half of a maximum field of view of the optical imaging system, and Semi-FOV is 42.32°, DT11 is a maximum effective radius of the object-side surface of the first lens, and DT11 is 1.59 mm, DT32 is a maximum effective radius of the image-side surface of the third lens, DT32 is 1.21 mm, and SD is a distance from the diaphragm to the image-side surface of the seventh lens on the optical axis, and SD is 3.64 mm.

Table 9 shows a table of basic parameters of the optical imaging system of Embodiment 5, wherein the units of the curvature radius, the thickness/distance and focal length are all millimeters (mm). Tables 10-1 and 10-2 show high-order coefficients that may be used for each aspheric mirror surface in Embodiment 5, wherein each aspheric surface type may be defined by formula (1) given in Embodiment 1 above.

TABLE 9

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinity | Infinity | | | | |
| S1 | Aspheric | 1.9812 | 0.8235 | 1.55 | 56.1 | 4.58 | −0.0903 |
| S2 | Aspheric | 8.0999 | 0.0808 | | | | 3.9870 |
| S3 | Aspheric | 5.5533 | 0.2214 | 1.68 | 19.2 | −8.78 | 0.7659 |
| S4 | Aspheric | 2.8290 | 0.1469 | | | | −1.5305 |
| S5 | Aspheric | 4.6373 | 0.3595 | 1.57 | 37.4 | 15.01 | −13.8683 |
| S6(STO) | Aspheric | 9.8288 | 0.3894 | | | | 9.0146 |
| S7 | Aspheric | −11.7835 | 0.3104 | 1.68 | 19.2 | −42.90 | −74.7774 |
| S8 | Aspheric | −20.0000 | 0.3684 | | | | −94.4318 |
| S9 | Aspheric | 11.0359 | 0.3027 | 1.62 | 25.9 | 200.00 | 0.2518 |
| S10 | Aspheric | 11.9864 | 0.5167 | | | | −0.0872 |
| S11 | Aspheric | 6.1572 | 0.7107 | 1.55 | 56.1 | 7.16 | −0.5038 |
| S12 | Aspheric | −10.2793 | 0.5186 | | | | 1.1520 |
| S13 | Aspheric | −4.3062 | 0.5230 | 1.55 | 56.1 | −3.83 | −1.7150 |
| S14 | Aspheric | 4.2439 | 0.3497 | | | | 0.0075 |
| S15 | Spherical | Infinity | 0.1100 | 1.52 | 64.2 | | |
| S16 | Spherical | Infinity | 0.4684 | | | | |
| S17 | Spherical | Infinity | | | | | |

TABLE 10-1

| Surface | | | | | | | |
|---|---|---|---|---|---|---|---|
| number | A4 | A6 | A8 | A10 | A12 | A14 | A16 |
| S1 | −3.2440E−02 | −1.5024E−02 | −4.9532E−03 | −1.0455E−03 | −1.0871E−04 | 5.4327E−05 | 2.9249E−05 |
| S2 | −2.7748E−02 | −1.5978E−03 | −1.0979E−03 | 7.7366E−04 | −2.0741E−04 | 9.8928E−05 | −3.1022E−05 |
| S3 | 4.6293E−03 | 1.3215E−02 | −1.3244E−03 | 9.9870E−04 | −4.3382E−04 | 9.1619E−05 | −5.0724E−05 |
| S4 | 4.3601E−02 | 1.2192E−02 | −2.2166E−03 | −7.8650E−04 | −8.6550E−04 | −2.0988E−04 | −6.1620E−05 |
| S5 | 7.1255E−02 | 1.8320E−02 | 3.9119E−03 | 6.7177E−04 | −1.3822E−04 | −8.2210E−05 | −3.4919E−05 |
| S6 | 3.8116E−03 | 5.7452E−03 | 1.6299E−03 | 5.1845E−04 | 1.3741E−04 | 4.4442E−05 | 8.7655E−06 |
| S7 | −2.0897E−01 | −1.7350E−02 | −3.2887E−03 | 2.6324E−05 | −1.1686E−04 | 4.0623E−05 | −6.3703E−05 |
| S8 | −2.8131E−01 | −1.4789E−03 | 6.6391E−03 | 5.4805E−03 | 1.9301E−03 | 8.5830E−04 | 1.2974E−04 |
| S9 | −5.8644E−01 | −3.3542E−02 | −1.0615E−02 | 7.6285E−03 | 6.2128E−03 | 4.7050E−03 | 2.1099E−03 |
| S10 | −7.3663E−01 | 8.9080E−02 | −2.0798E−02 | 2.0660E−03 | 1.6395E−03 | 1.6617E−03 | −4.5345E−04 |
| S11 | −1.5978E+00 | 3.3627E−01 | −1.5533E−02 | −1.2311E−02 | 1.8413E−02 | −1.0781E−02 | −3.2902E−03 |
| S12 | −6.9166E−01 | 1.2274E−01 | 6.4425E−02 | −3.2018E−02 | 3.5162E−02 | −1.1220E−02 | −6.2806E−03 |
| S13 | 2.2938E−01 | 4.0967E−01 | −2.4075E−01 | 9.0401E−02 | −2.0435E−02 | −2.8729E−03 | 7.4829E−03 |
| S14 | −4.6418E+00 | 5.4814E−01 | −2.2450E−01 | 6.1979E−02 | −5.4630E−02 | 2.4416E−03 | −1.2030E−03 |

TABLE 10-2

| Surface | | | | | | | |
|---|---|---|---|---|---|---|---|
| number | A18 | A20 | A22 | A24 | A26 | A28 | A30 |
| S1 | 9.1509E−06 | −2.3264E−06 | −2.4723E−07 | 0.0000E+00 | 0.0000E+00 | 0.0000E+00 | 0.0000E+00 |
| S2 | 9.8410E−06 | −7.4829E−06 | 0.0000E+00 | 0.0000E+00 | 0.0000E+00 | 0.0000E+00 | 0.0000E+00 |
| S3 | −1.9201E−07 | −4.4661E−06 | −4.2335E−09 | 0.0000E+00 | 0.0000E+00 | 0.0000E+00 | 0.0000E+00 |
| S4 | −1.9167E−06 | 3.3076E−06 | 0.0000E+00 | 0.0000E+00 | 0.0000E+00 | 0.0000E+00 | 0.0000E+00 |
| S5 | −7.0189E−06 | −5.6824E−06 | 0.0000E+00 | 0.0000E+00 | 0.0000E+00 | 0.0000E+00 | 0.0000E+00 |
| S6 | 4.5889E−06 | 7.4842E−08 | 0.0000E+00 | 0.0000E+00 | 0.0000E+00 | 0.0000E+00 | 0.0000E+00 |
| S7 | −2.2416E−05 | −2.4565E−05 | 6.7562E−06 | 0.0000E+00 | 0.0000E+00 | 0.0000E+00 | 0.0000E+00 |
| S8 | −9.5327E−07 | −3.3944E−05 | 0.0000E+00 | 0.0000E+00 | 0.0000E+00 | 0.0000E+00 | 0.0000E+00 |
| S9 | 1.8701E−04 | −4.5242E−04 | −4.2999E−04 | −2.0667E−04 | −6.8956E−05 | 0.0000E+00 | 0.0000E+00 |
| S10 | −3.9291E−04 | 3.2542E−04 | 2.0266E−04 | −2.9837E−05 | −6.4652E−05 | 0.0000E+00 | 0.0000E+00 |
| S11 | 3.8037E−03 | 1.1719E−03 | −1.6113E−03 | −2.6159E−04 | 4.2678E−04 | 6.8357E−05 | −6.8828E−05 |
| S12 | 5.5325E−04 | 2.4351E−03 | −2.6087E−05 | −5.8663E−04 | 4.8592E−05 | 1.4083E−04 | 1.7762E−05 |
| S13 | −5.0055E−03 | 7.9941E−04 | 1.3807E−03 | −1.1221E−03 | 1.9003E−04 | 1.6282E−04 | −9.9782E−05 |
| S14 | 2.0684E−03 | −2.3194E−03 | −3.6190E−04 | −4.5091E−05 | 4.6840E−04 | −1.7455E−04 | −2.6678E−04 |

FIG. 10A shows a longitudinal aberration curve of the optical imaging system in Embodiment 5, which represents deviations of a convergence focal point after lights with different wavelengths passes through the lens. FIG. 10B shows an astigmatism curve of the optical imaging system of Embodiment 5, which represents a tangential image surface curvature and a sagittal image surface curvature. FIG. 10C shows a distortion curve of the optical imaging system of Embodiment 5, which represents distortion values corresponding to different image heights. FIGS. 10A-10C show that the optical imaging system provided in Embodiment 5 may achieve desirable imaging quality.

### EMBODIMENT 6

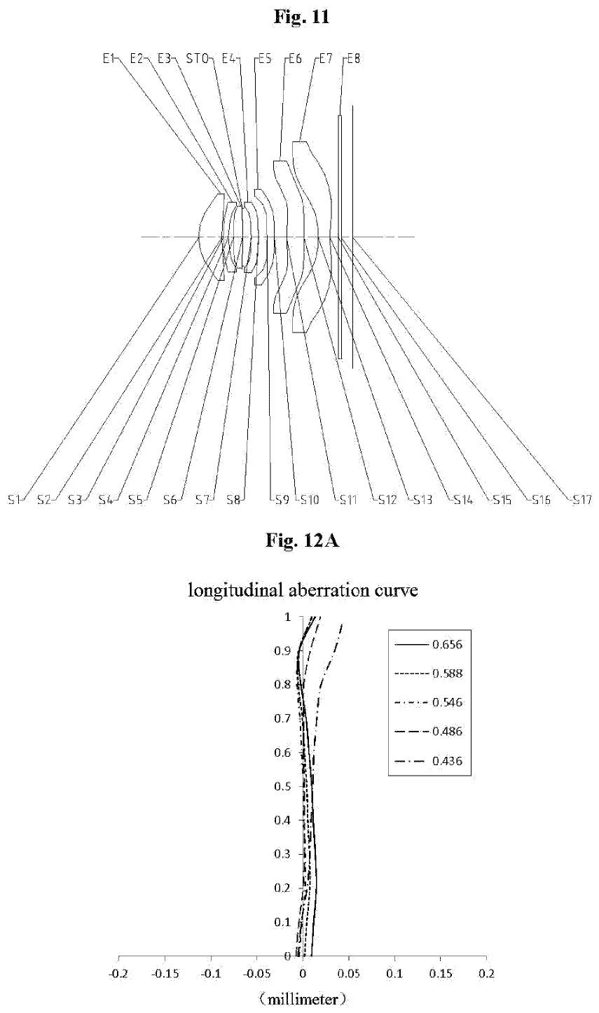

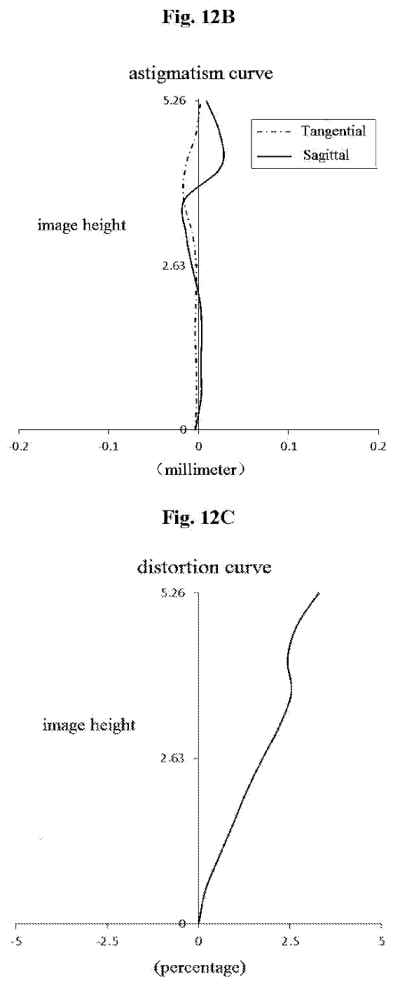

An optical imaging system according to Embodiment 6 of the disclosure is described below with reference to FIGS. 11-12C. FIG. 11 shows a structural schematic diagram of an optical imaging system according to Embodiment 6 of the disclosure.

As shown in FIG. 11, the optical imaging system sequentially includes from an object side to an image side: a first lens E1, a second lens E2, a third lens E3, a diaphragm STO, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, and an image-side surface S2 thereof is a concave surface. The second lens E2 has a negative refractive power, an object-side surface S3 thereof is a convex surface, and an image-side surface S4 thereof is a concave surface. The third lens E3 has a positive refractive power, an object-side surface S5 thereof is a convex surface, and an image-side surface S6 thereof is a convex surface. The fourth lens E4 has a negative refractive power, an object-side surface S7 thereof is a concave surface, and an image-side surface S8 thereof is a convex surface. The fifth lens E5 has a positive refractive power, an object-side surface S9 thereof is a convex surface, and an image-side surface S10 thereof is a concave surface. The sixth lens E6 has a positive refractive power, an object-side surface S11 thereof is a convex surface, and an image-side surface S12 thereof is a convex surface. The seventh lens E7 has a negative refractive power, an object-side surface S13 thereof is a concave surface, and an image-side surface S14 thereof is a concave surface. The optical filter E8 has an object-side surface S15 and an image-side surface S16. Light from an object sequentially passes through each of the surfaces from S1 to S16 and is finally imaged on the imaging surface S17.

In this embodiment, f is a total effective focal length of the optical imaging lens, and f is 5.54 mm, TTL is a total length of the optical imaging system, and TTL is 6.20 mm, ImgH is a half of a diagonal length of an effective pixel region on the imaging surface S17 of the optical imaging system, and ImgH is 5.26 mm, Semi-FOV is a half of a maximum field of view of the optical imaging system, and Semi-FOV is 42.25°, DT11 is a maximum effective radius of the object-side surface of the first lens, and DT11 is 1.82 mm, DT32 is a maximum effective radius of the image-side surface of the third lens, and DT32 is 1.22 mm, and SD is a distance from the diaphragm to the image-side surface of the seventh lens on the optical axis, and SD is 3.51 mm.

Table 11 shows a table of basic parameters of the optical imaging system of Embodiment 6, wherein the units of the curvature radius, the thickness/distance and focal length are all millimeters (mm). Tables 12-1 and 12-2 show high-order coefficients that may be used for each aspheric mirror surface in Embodiment 6, wherein each aspheric surface type may be defined by formula (1) given in Embodiment 1 above.

TABLE 11

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinity | Infinity | | | | |
| S1 | Aspheric | 2.0249 | 0.9275 | 1.55 | 56.1 | 4.49 | −0.1370 |
| S2 | Aspheric | 9.6815 | 0.0612 | | | | 1.7811 |
| S3 | Aspheric | 5.9717 | 0.2000 | 1.68 | 19.2 | −9.65 | −0.8924 |
| S4 | Aspheric | 3.0817 | 0.2117 | | | | −1.0497 |
| S5 | Aspheric | 11.4365 | 0.3616 | 1.57 | 37.4 | 14.56 | −24.3811 |
| S6(STO) | Aspheric | −30.0168 | 0.3532 | | | | −47.2383 |
| S7 | Aspheric | −11.2609 | 0.2885 | 1.68 | 19.2 | −23.66 | −33.4581 |
| S8 | Aspheric | −38.0540 | 0.3458 | | | | −99.0000 |
| S9 | Aspheric | 16.2096 | 0.2977 | 1.62 | 25.9 | 100.00 | 48.3559 |
| S10 | Aspheric | 21.7906 | 0.4914 | | | | 99.0000 |
| S11 | Aspheric | 5.5167 | 0.7010 | 1.55 | 56.1 | 7.67 | 0.7781 |
| S12 | Aspheric | −16.7101 | 0.5704 | | | | −31.9859 |
| S13 | Aspheric | −4.3416 | 0.4658 | 1.55 | 56.1 | −3.78 | −1.8579 |
| S14 | Aspheric | 4.0964 | 0.3467 | | | | 0.0188 |
| S15 | Spherical | Infinity | 0.1100 | 1.52 | 64.2 | | |
| S16 | Spherical | Infinity | 0.4672 | | | | |
| S17 | Spherical | Infinity | | | | | |

TABLE 12-1

| Surface | | | | | | | |
|---|---|---|---|---|---|---|---|
| number | A4 | A6 | A8 | A10 | A12 | A14 | A16 |
| S1 | −6.1233E−02 | −2.9731E−02 | −9.5983E−03 | −1.5871E−03 | 2.1295E−04 | 2.8681E−04 | 9.1357E−05 |
| S2 | −2.7983E−02 | −7.3805E−05 | −1.2192E−03 | 1.2759E−03 | −2.1669E−04 | 1.3620E−04 | −2.8768E−05 |
| S3 | 4.6293E−03 | 1.3215E−02 | −1.3244E−03 | 9.9870E−04 | −4.3382E−04 | 9.1619E−05 | −5.0724E−05 |
| S4 | 4.9362E−02 | 1.4725E−02 | 5.1161E−04 | −3.0702E−04 | −9.1270E−04 | −3.9974E−04 | −2.0131E−04 |
| S5 | 6.5857E−02 | 2.0725E−02 | 5.0685E−03 | 7.3576E−04 | −2.7318E−04 | −2.6154E−04 | −1.4921E−04 |
| S6 | 3.8116E−03 | 5.7452E−03 | 1.6299E−03 | 5.1845E−04 | 1.3741E−04 | 4.4442E−05 | 8.7655E−06 |
| S7 | −2.0897E−01 | −1.7350E−02 | −3.2887E−03 | 2.6324E−05 | −1.1686E−04 | 4.0623E−05 | −6.3703E−05 |
| S8 | −2.7768E−01 | −5.8577E−03 | 5.6520E−03 | 6.0038E−03 | 2.3658E−03 | 1.2294E−03 | 3.5814E−04 |
| S9 | −5.6356E−01 | −2.7305E−02 | −7.8193E−03 | 1.0580E−02 | 6.6882E−03 | 4.2841E−03 | 1.4552E−03 |
| S10 | −7.3663E−01 | 8.9080E−02 | −2.0798E−02 | 2.0660E−03 | 1.6395E−03 | 1.6617E−03 | −4.5345E−04 |
| S11 | −1.5978E+00 | 3.3627E−01 | −1.5533E−02 | −1.2311E−02 | 1.8413E−02 | −1.0781E−02 | −3.2902E−03 |
| S12 | −6.2978E−01 | 1.2228E−01 | 3.5680E−02 | −2.7411E−02 | 4.3135E−02 | −1.5088E−02 | −4.5388E−03 |
| S13 | 2.2938E−01 | 4.0967E−01 | −2.4075E−01 | 9.0401E−02 | −2.0435E−02 | −2.8729E−03 | 7.4829E−03 |
| S14 | −4.5473E+00 | 6.3092E−01 | −2.2207E−01 | 6.2611E−02 | −5.2601E−02 | 1.4213E−02 | 1.4509E−02 |

TABLE 12-2

| Surface | | | | | | | |
|---|---|---|---|---|---|---|---|
| number | A18 | A20 | A22 | A24 | A26 | A28 | A30 |
| S1 | 6.1085E−06 | −9.9263E−06 | −9.2589E−07 | 0.0000E+00 | 0.0000E+00 | 0.0000E+00 | 0.0000E+00 |
| S2 | 1.1834E−05 | 1.5645E−06 | 0.0000E+00 | 0.0000E+00 | 0.0000E+00 | 0.0000E+00 | 0.0000E+00 |
| S3 | −1.9201E−07 | −4.4661E−06 | −4.2335E−09 | 0.0000E+00 | 0.0000E+00 | 0.0000E+00 | 0.0000E+00 |
| S4 | −5.3791E−05 | −9.7732E−06 | 0.0000E+00 | 0.0000E+00 | 0.0000E+00 | 0.0000E+00 | 0.0000E+00 |
| S5 | −6.5651E−05 | −1.6674E−05 | 0.0000E+00 | 0.0000E+00 | 0.0000E+00 | 0.0000E+00 | 0.0000E+00 |
| S6 | 4.5889E−06 | 7.4842E−08 | 0.0000E+00 | 0.0000E+00 | 0.0000E+00 | 0.0000E+00 | 0.0000E+00 |
| S7 | −2.2416E−05 | −2.4565E−05 | 6.7562E−06 | 0.0000E+00 | 0.0000E+00 | 0.0000E+00 | 0.0000E+00 |
| S8 | 1.1991E−04 | 1.1497E−06 | 0.0000E+00 | 0.0000E+00 | 0.0000E+00 | 0.0000E+00 | 0.0000E+00 |
| S9 | −1.6120E−04 | −5.0672E−04 | −3.7923E−04 | −1.6175E−04 | −4.7069E−05 | 0.0000E+00 | 0.0000E+00 |
| S10 | −3.9291E−04 | 3.2542E−04 | 2.0266E−04 | −2.9837E−05 | −6.4652E−05 | 0.0000E+00 | 0.0000E+00 |
| S11 | 3.8037E−03 | 1.1719E−03 | −1.6113E−03 | −2.6159E−04 | 4.2678E−04 | 6.8357E−05 | −6.8828E−05 |
| S12 | −8.3764E−04 | −4.0416E−04 | −2.3121E−03 | −1.4973E−03 | −6.8266E−04 | −5.2207E−04 | −2.5515E−04 |
| S13 | −5.0055E−03 | 7.9941E−04 | 1.3807E−03 | −1.1221E−03 | 1.9003E−04 | 1.6282E−04 | −9.9782E−05 |
| S14 | 1.5154E−02 | 5.4372E−03 | 5.5984E−03 | 5.0575E−03 | 4.2587E−03 | 1.5993E−03 | 2.8724E−04 |

FIG. 12A shows a longitudinal aberration curve of the optical imaging system in Embodiment 6, which represents deviations of a convergence focal point after lights with different wavelengths passes through the lens. FIG. 12B shows an astigmatism curve of the optical imaging system of Embodiment 6, which represents a tangential image surface curvature and a sagittal image surface curvature. FIG. 12C shows a distortion curve of the optical imaging system of Embodiment 6, which represents distortion values corresponding to different image heights. FIGS. 12A-12C show that the optical imaging system provided in Embodiment 6 may achieve desirable imaging quality.

To summarize, Embodiments 1-6 separately satisfy relations shown in Table 13.

TABLE 13

| Conditional expression/embodiments | 1 | 2 | 3 | 4 | 5 | 6 |
|---|---|---|---|---|---|---|
| TTL/ImgH | 1.18 | 1.18 | 1.18 | 1.18 | 1.18 | 1.18 |
| Tan(FOV)/SD(mm⁻¹) | 3.09 | 3.09 | 2.95 | 2.91 | 2.93 | 2.96 |
| f/EPD | 1.89 | 1.89 | 1.89 | 1.89 | 1.89 | 1.89 |
| f3/f1 | 3.01 | 4.27 | 4.61 | 3.35 | 3.28 | 3.24 |
| f6/f7 | −1.93 | −1.63 | −1.91 | −1.88 | −1.87 | −2.03 |
| f4/f | −8.40 | −3.56 | −5.82 | −6.67 | −7.74 | −4.27 |
| R2/R1 | 3.40 | 1.69 | 3.67 | 3.93 | 4.09 | 4.78 |
| R3/R4 | 1.89 | 0.93 | 1.90 | 1.97 | 1.96 | 1.94 |
| R12/R11 | −1.85 | −1.19 | −2.50 | −1.82 | −1.67 | −3.03 |
| T23/T12 | 2.90 | 3.69 | 3.16 | 2.13 | 1.82 | 3.46 |
| CT1/CT2 | 3.24 | 3.27 | 4.27 | 3.25 | 3.72 | 4.64 |
| (CT3 + CT4)/T34 | 1.37 | 2.68 | 1.78 | 1.64 | 1.72 | 1.84 |
| (T45 + T56J/CT5 | 3.08 | 2.98 | 3.21 | 3.06 | 2.92 | 2.81 |
| (CT6 + CT7)/T67 | 3.00 | 1.79 | 2.29 | 2.66 | 2.38 | 2.05 |
| DT11/DT32 | 1.29 | 1.22 | 1.36 | 1.31 | 1.32 | 1.48 |

The disclosure also provides an imaging device, where the electronic photosensitive element may be a Charge Coupled Device (CCD) or a Complementary Metal Oxide Semiconductor (CMOS). The imaging device may be a stand-alone imaging apparatus, such as a digital camera, or an imaging module integrated on mobile electronic apparatuses, such as a cell phone. The imaging device is equipped with the optical imaging system described above.

The above description is merely illustrative of preferred embodiment of the disclosure and of principles of the technology employed. It should be understood by those skilled in the art that the invention scope referred to in the disclosure is not limited to the technical solutions in which the above-described technical features are specifically combined, but also encompasses other technical solutions in which the above-described technical features or equivalent features thereof are arbitrarily combined without departing from the inventive concept. For example, technical solutions formed by interchanging the features described above with (but not limited to) technical features disclosed in the disclosure that have similar functions.

What is claimed is:

1. An optical imaging system, sequentially comprising from an object side to an image side along an optical axis:
a first lens with a positive refractive power;
a second lens with a refractive power;
a third lens with a refractive power;
a diaphragm;
a fourth lens with a negative refractive power;
a fifth lens with a positive refractive power, an image-side surface thereof is a concave surface;
a sixth lens with a refractive power, an image-side surface thereof is a convex surface; and
a seventh lens with a refractive power;
at least one mirror surface from an object-side surface of the first lens to an image-side surface of the seventh lens is an aspheric mirror surface;
TTL is a distance from the object-side surface of the first lens to an imaging surface of the optical imaging system on the optical axis, ImgH is a half of a diagonal length of an effective pixel region on the imaging surface of the optical imaging system, and TTL and ImgH satisfy: TTL/ImgH<1.2; and
FOV is a maximum field of view of the optical imaging system, SD is a distance from the diaphragm to the image-side surface of the seventh lens on the optical axis, and FOV and SD satisfy: 2.5 mm⁻¹<Tan(FOV)/SD<3.5 mm⁻¹.

2. The optical imaging system according to claim 1, wherein an effective focal length f3 of the third lens and an effective focal length f1 of the first lens satisfy: 3.0<f3/f<5.0.

3. The optical imaging system according to claim 1, wherein an effective focal length f6 of the sixth lens and an effective focal length f7 of the seventh lens satisfy: −2.5<f6/f7<−1.58.

4. The optical imaging system according to claim 1, wherein an effective focal length f4 of the fourth lens and a total effective focal length f of the optical imaging system satisfy: −8.5<f4/f<−3.5.

5. The optical imaging system according to claim 1, wherein a curvature radius R1 of the object-side surface of the first lens and a curvature radius R2 of an image-side surface of the first lens satisfy: 1.5<R2/R1<5.0.

6. The optical imaging system according to claim 1, wherein a curvature radius R3 of an object-side surface of the second lens and a curvature radius R4 of an image-side surface of the second lens satisfy: 0.5<R3/R4<2.0.

7. The optical imaging system according to claim 1, wherein a curvature radius R11 of an object-side surface of the sixth lens and a curvature radius R12 of an image-side surface of the sixth lens satisfy: −3.5<R12/R11<−1.0.

8. The optical imaging system according to claim 1, wherein a spacing distance T12 between the first lens and the second lens on the optical axis and a spacing distance T23 between the second lens and the third lens on the optical axis satisfy: 1.5<T23/T12<4.0.

9. The optical imaging system according to claim 1, wherein a center thickness CT1 of the first lens on the optical axis and a center thickness CT2 of the second lens on the optical axis satisfy: 3.0<CT1/CT2<5.0.

10. The optical imaging system according to claim 1, wherein a center thickness CT3 of the third lens on the optical axis, a center thickness CT4 of the fourth lens on the optical axis and a spacing distance T34 between the third lens and the fourth lens on the optical axis satisfy: 1.0<(CT3+CT4)/T34<3.0.

11. The optical imaging system according to claim 1, wherein a spacing distance T45 between the fourth lens and the fifth lens on the optical axis, a spacing distance T56 between the fifth lens and the sixth lens on the optical axis and a center thickness CT5 of the fifth lens on the optical axis satisfy: 2.5<(T45+T56)/CT5<3.5.

12. The optical imaging system according to claim 1, wherein a center thickness CT6 of the sixth lens on the optical axis, a center thickness CT7 of the seventh lens on the optical axis and a spacing distance T67 between the sixth lens and the seventh lens on the optical axis satisfy: 1.5<(CT6+CT7)/T67<3.1.

13. The optical imaging system according to claim 1, wherein a maximum effective radius DT11 of the object-side surface of the first lens and a maximum effective radius DT32 of an image-side surface of the third lens satisfy: 1.0<DT11/DT32<1.5.

14. The optical imaging system according to claim 1, wherein a total effective focal length f of the optical imaging system and an Entrance Pupil Diameter (EPD) of the optical imaging system satisfy: f/EPD<2.0.

15. An optical imaging system, sequentially comprising from an object side to an image side along an optical axis:
a first lens with a positive refractive power;
a second lens with a refractive power;
a third lens with a refractive power;
a diaphragm;
a fourth lens with a negative refractive power;
a fifth lens with a positive refractive power, an image-side surface thereof is a concave surface;
a sixth lens with a refractive power, an image-side surface thereof is a convex surface; and
a seventh lens with a refractive power; wherein
at least one mirror surface from an object-side surface of the first lens to an image-side surface of the seventh lens is an aspheric mirror surface;
TTL is a distance from the object-side surface of the first lens to an imaging surface of the optical imaging system on the optical axis, ImgH is a half of a diagonal length of an effective pixel region on the imaging surface of the optical imaging system, and TTL and ImgH satisfy: TTL/ImgH<1.2; and
a spacing distance T45 between the fourth lens and the fifth lens on the optical axis, a spacing distance T56 between the fifth lens and the sixth lens on the optical axis and a center thickness CT5 of the fifth lens on the optical axis satisfy: 2.5<(T45+T56)CT5<3.5.

16. The optical imaging system according to claim 15, wherein an effective focal length f3 of the third lens and an effective focal length f1 of the first lens satisfy: 3.0<f3/f1<5.0.

17. The optical imaging system according to claim 15, wherein an effective focal length f6 of the sixth lens and an effective focal length f7 of the seventh lens satisfy: −2.5<f6/f7<−1.58.

18. The optical imaging system according to claim 15, wherein an effective focal length f4 of the fourth lens and a total effective focal length f of the optical imaging system satisfy: −8.5<f4/f<−3.5.

19. The optical imaging system according to claim 15, wherein a curvature radius R1 of the object-side surface of the first lens and a curvature radius R2 of an image-side surface of the first lens satisfy: 1.5<R2/R1<5.0.

20. The optical imaging system according to claim 15, wherein a curvature radius R3 of an object-side surface of the second lens and a curvature radius R4 of an image-side surface of the second lens may satisfy: 0.5<R3/R4<2.0.
